(19) United States
(12) Patent Application Publication
(10) Pub. No.: US 2007/0247466 A1
(43) Pub. Date: Oct. 25, 2007

(54) Image processing apparatus and program

(75) Inventors: Yukio Kumazawa, Kanagawa (JP); Takashi Nagao, Kanagawa (JP); Junichi Kaneko, Kanagawa (JP); Yasuhiko Kaneko, Kanagawa (JP)

Correspondence Address: OLIFF & BERRIDGE, PLC, P.O. BOX 19928, ALEXANDRIA, VA, 22320, US

(73) Assignees: FUJI XEROX CO., LTD, Tokyo (JP); FUJIFILM CORPORATION, Tokyo (JP)

(21) Appl. No.: 11/707,025

(22) Filed: Feb. 16, 2007

(30) Foreign Application Priority Data
Apr. 20, 2006 (JP) 2006-116640

(51) Int. Cl. G06T 1/20

(52) U.S. Cl. 345/506

(57) ABSTRACT

An image processing apparatus including an image processing unit structured to include one or more image processing modules and one or more buffer modules each having a buffer for storing image data, the respective modules being connected in a pipe line mode or a directed acyclic graph mode. Each of the buffer modules including a write unit that when image data to be written is input from the module at the proceeding stage, switches a write method depending on whether or not the input image data is compressed and writes the image data to the buffer; and a read unit that when image data is requested from the module at the following stage, switches an output method depending on whether or not the read image data is compressed, reads the image data from the buffer, and outputs the image data to the module at the following stage.

### CROSS-REFERENCE TO RELATED APPLICATION

This application claims priority under 35 USC 119 from Japanese Patent Application No. 2006-116640 filed Apr. 20, 2006.

### BACKGROUND OF THE INVENTION

1. Technical Field

The present invention relates to an image processing apparatus and a storage medium in which a program is stored, and, more particularly, to an image processing apparatus having an image processing unit constructed by coupling an image processing module and a buffer module in a pipeline mode or a directed acyclic graph mode and to a storage medium in which an image processing program is stored to cause a computer to act as the image processing apparatus.

2. Related Art

In an image processing apparatus for subjecting input image data to image processing, a desk top publishing (DTP) system capable of handling an image, a print system for recording an image shown by input image data onto a recording material, and the like, the input image data is subjected to various kinds of image processing such as enlargement/reduction, rotation, affin conversion, color conversion, filter processing, image synthesization. In these apparatus and system, when an attribute of the image data, and contents, a procedure, parameters, and the like of the image processing carried out to the image data are fixed, the image processing may be carried out by specifically designed hardware. However, when various types of image having, for example, a different color space and a different number of bits per unit pixel are input, or when the contents, the procedure, the parameters, and the like of the image processing are variously changed, an arrangement that can flexibly change the image processing to be carried out is required.

To satisfy such requirements, there is proposed a technology for making it possible to carry out desired image processing by connecting a programmable processing module in a pipeline mode and a directed acyclic graph (DAG) mode. The technology realizes a digital video signal processing apparatus that can carry out high level arithmetic operations at high speed and has a high degree of freedom for changes to function and system by such an arrangement that the contents of arithmetic operation processing of plural programmable arithmetic operation processing units and the connection modes of the programmable arithmetic operation processing units carried out by a network unit can be arbitrarily set from the outside through a host control means.

Further, as a technology that can be applied also to image processing, there is proposed a processor having plural storage means, a data processing means, and a start-up priority determination means. The data processing means receives input data from a single input storage means of the plural storage means as to an execution unit as one of time-shared processings and stores a result of processing to a single output storage means, and the start-up priority determination means determines an execution status of the execution unit from the information of an amount of data stored in the storage means and determines start-up priority of the execution unit.

When an image processing apparatus for carrying out desired image processing by arbitrarily combining plural types of image processing modules as in the technology disclosed in the above paragraph [0003], a problem arises as described below. That is, the respective image processing modules have a unit (for example, a unit of pixel, a unit of one line, a unit of plural lines, a unit of a sheet, and the like) that is liable to be processed depending on the types and the contents of image processings to be carried out. However, to couple the respective image processing modules with each other in an arbitrary order and to cause them to carry out processing in a harmonized status, it is necessary to set the output units of all the image processing modules to the same unit or to arrange the respective image processing modules so that they cope with an arbitrary input unit, which makes the arrangement of the respective image processing modules complex. Further, since the respective image processing modules operate in association with other image processing modules, they require a portion for controlling image data delivery processing between the other image processing modules coupled with the module itselfs, in addition to a portion for actually carrying out image processing to input image data, which makes the arrangement of the respective image processing modules more complex.

The above problem can be overcome by employing an arrangement in which buffers (storage means) are disposed to the proceeding and following stages of image processing modules (data processing means) and causing the respective image processing modules to carry out various types of image processings as well as arranging the respective image processing modules such that they obtain image data from the buffers in a unit that is easy to process, according to the type and the contents of image processing to be carried out, as in the technology disclosed in the above paragraph

However, recently, a digital image is made finer and the size of digital image data increases accordingly. In, for example, color image data showing color image by RGB, when resolution is 400 dpi, the size of the color image data is 44 Mega Bytes in A4 and 88 Mega Bytes in A3 size, and when resolution is 600 dpi, it is 100 Mega Bytes in A4 size and 300 Mega Bytes in A3 size. Accordingly, the arrangement in which buffers are disposed to the proceeding and the following stages of image processing modules as in the technology disclosed in Patent Document 2, the storage capacity of the respective buffers must be increased, and a problem arises in that resources such as memories constituting the respective buffers are consumed in a large amount. Further, the read/write speed of storage devices such as a memory is lower than the operating speed of a processor, and a difference between the speeds of them is more increased as the performance of the processor is enhanced. Accordingly, as the size of image data increases, the time necessary to write and read image data to and from a buffer becomes a bottle neck in the processing speed of an image processing apparatus, and a problem also arises in that processing speed is lowered.

### SUMMARY

The present invention has been made in view of the above facts and provides an image processing apparatus capable of suppressing an increase of a buffer capacity and suppressing a decreases of processing speed even if image data of a large size is handled, and a storage medium in which a image processing program is stored.

According to an aspect of the present invention, there is provided an image processing apparatus including an image processing unit structured to include one or more image processing modules, each of which has a function for obtaining image data of a unit amount of data from a proceeding stage of the module itself, carrying out predetermined image processing with respect to the obtained image data, and outputting the image data subjected to the predetermined image processing or a result of processing of the predetermined image processing to a following stage of the module itself, the one or more image processing modules being selected from plural types of image processing modules which carry out image processing different in type or contents from each other; and one or more buffer modules each having a buffer for storing image data; the image processing unit being structured such that the buffer modules are coupled to at least one of a proceeding stage and/or a following stage of the selected respective image processing modules with the modules coupled to each other in a pipe line mode or in a directed acyclic graph mode; each of the buffer modules including a write unit that when image data to be written is input from the module at the proceeding stage, switches a write method depending on whether or not the input image data is compressed, and writes the image data to the buffer; and a read unit that when image data is requested from the module at the following stage, switches an output method depending on whether or not the read image data is compressed, reads the image data from the buffer and outputs the image data to the module at the following stage.

According to another aspect of the present invention, there is provided a storage medium in which is stored an image processing program for causing a computer to acts as an image processing apparatus including an image processing unit structured to include one or more image processing modules, each of which has a function for obtaining image data of a unit amount of data from a proceeding stage of the module itself, carrying out predetermined image processing with respect to the obtained image data, and outputting a result of processing of the image data subjected to the predetermined image processing or a result of processing of the predetermined image processing to a following stage of the module itself, the one or more image processing modules being selected from plural types of image processing modules which carry out image processing different in type or contents from each other; and one or more buffer modules each having a buffer for storing image data; the image processing unit being structured such that the buffer modules are coupled to at least one of a proceeding stage and/or a following stage of the selected respective image processing modules with the modules coupled to each other in a pipe line mode or in a directed acyclic graph mode; wherein each of the buffer modules comprises: a write unit that when image data to be written is input from the module at the proceeding stage, switches a write method depending on whether or not the input image data is compressed, thereby writing the image data to the buffer; and a read unit that when image data is requested from the module at the following stage, switches an output method depending on whether or not the read image data is compressed, reads the image data from the buffer, and outputs the image data to the module at the following stage.

Other aspects, features and advantages of the present invention will become apparent from the following description taken in conjunction with the accompanying drawings.

### BRIEF DESCRIPTION OF THE DRAWINGS

Exemplary embodiments of the present invention will be described in detail based on the following figures, in which:

FIG. 1 is a block diagram showing a schematic arrangement of a computer (image processing apparatus) according to an embodiment of the present invention;

FIGS. 2A to 2C are block diagrams showing an arrangement example of an image processing unit;

FIG. 3 is a flowchart showing contents of data write processing carried out by a write controller of a buffer module;

FIGS. 4A to 4C are schematic views explaining a case in which image data to be written straddles plural storing unit buffer regions;

FIG. 5 is a flowchart showing contents of data read processing carried out by a read controller of the buffer module;

FIGS. 6A to 6C are schematic views explaining a case in which image data to be read straddles the plural storing unit buffer regions;

FIG. 7 is a flowchart showing contents of image processing module control processing carried out by a controller of a image processing module;

FIG. 8A is a block diagram showing a schematic arrangement of an image processing module and processing carried out by the image processing module, respectively;

FIG. 8B is a block diagram showing a schematic arrangement of the buffer module and processing carried out by the buffer module, respectively;

FIGS. 9A to 9D are flowcharts showing contents of block unit control processing carried out by a processing management unit;

FIG. 10 is a schematic view explaining a flow of image processing in the image processing unit; and

FIG. 11 is a schematic view explaining a flow of block unit processing in an embodiment in which a buffer module directly requests image data to an image processing module at a proceeding stage.

### DETAILED DESCRIPTION

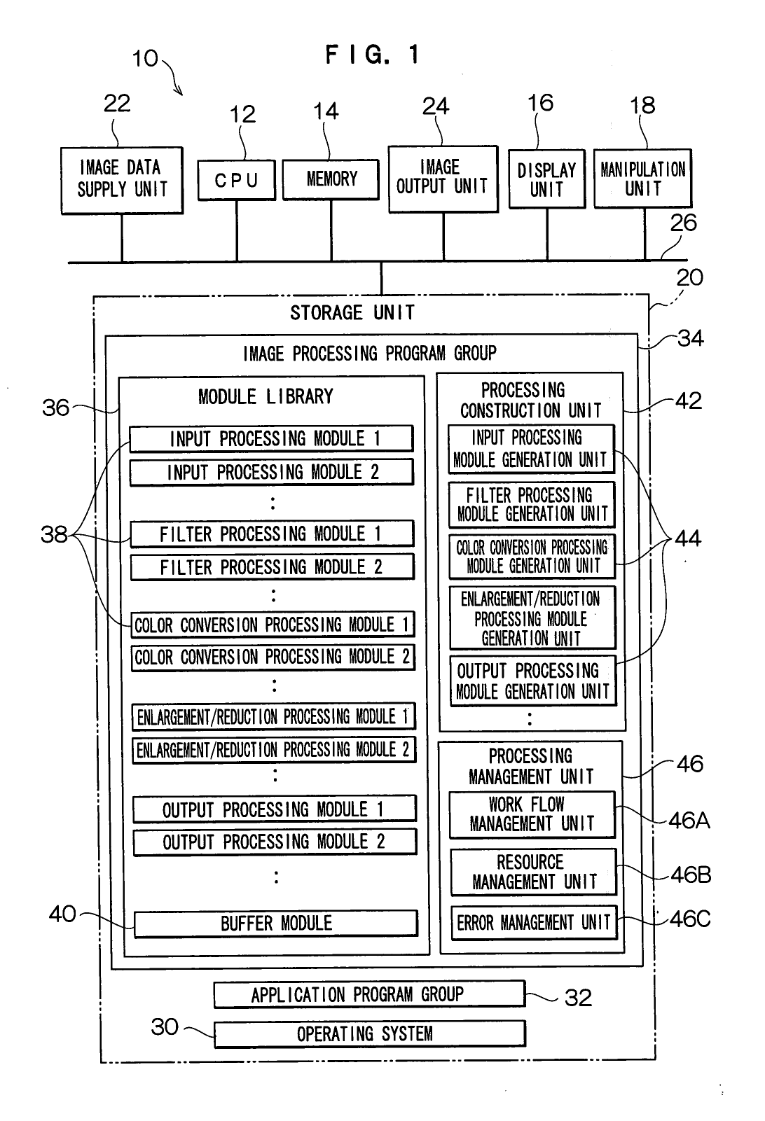

An example of an embodiment of the present invention will be described below in detail with reference to the drawings. FIG. 1 shows a computer 10 capable of acting as an image processing apparatus according to the present invention. Note that the computer 10 may be built into an arbitrary image handling device in which the necessary image processing is carried out, such as a copy machine, a printer, a facsimile apparatus, a multi-function machine having the functions of these apparatuses, a scanner, a photo printer, or the computer 10 may be an independent computer such as a personal computer (PC), and further may be a computer built into mobile equipment such as a personal digital assistant (PDA), a mobile phone or the like.

The computer 10 includes a CPU 12, a memory 14, a display unit 16, a manipulation unit 18, a storage unit 20, an image data supply unit 22, and an image output unit 24, which are connected to each other through a bus. When the computer 10 is built into the image handling device as described above, a display panel composed of an LCD and the like, a ten key, and the like which are disposed on the image handling device can be used as the display unit 16 and the manipulation unit 18. Further, when the computer 10 is an independent computer, a display, a keyboard, a mouse, and the like connected to the computer can be used as the display unit 16 and the manipulation unit 18. Further, although a hard disk drive (HHD) is preferable as the storage unit 20, it is also possible to use other nonvolatile memory means such as flash memory in place of it.

Further, it is sufficient as long as the image data supply unit 22 can supply image data to be processed, and an image reading unit, for outputting an image data by reading an image recorded on a recording medium, for example, paper, photographic film, and the like, a receiving unit for receiving image data from outside through a communications line, an image storage unit (the memory 14 or the storage unit 20) and the like for storing image data can be applied as the image data supply unit 22. Further, it is sufficient as long as the image output unit 24 can output image data subjected to image processing or can output an image showing the image data, and, for example, an image recording unit for recording an image shown by image data onto a recording material such as paper, photographic sensitive material, a display unit for displaying the image shown by the image data on a display and the like, a writing unit for writing the image data to a recording medium, and a transmission unit for transmitting the image data through a communications line can be applied as the image output unit 24. Further, the image output unit 24 may be a image storage unit (the memory 14 or the storage unit 20) for simply storing the image data subjected to the image processing.

As shown in FIG. 1, as various types of programs carried out by the CPU 12, the storage unit 20 stores: a program of an operating system 30, for managing resources such as the memory 14, execution of programs carried out by the CPU 12, communication between the outside and the computer 10, and the like; an image processing program group 34, for causing the computer 10 to act as the image processing apparatus according to the present invention; and program(s) of various types of application 32 (in FIG. 1, shown as the application program group 32), for causing the image processing apparatus to carry out desired image processing, executed by the CPU 12 carrying out the image processing program groups.

The image processing program group 34 is a program developed for the purpose of reducing the burden of development when the various types of the image handing device and mobile devices described above are developed and reducing the burden of development when an image processing program that can be utilized by a PC and the like is developed, and is a program that can be commonly used by various types of devices (platforms) such as the various types of image handing device, mobile devices, and PCs. The image processing program group 34 corresponds to an image processing program according to the present invention. The image processing apparatus realized by the image processing program group 34 follows a construction instruction from the application 32 and constructs an image processing unit for carrying out image processing instructed by the application 32, and follows an execution instruction from the application 32 and carries out image processing using the image processing unit (explained later in detail). The image processing program group 34 provides the application 32 with an interface for instructing construction of an image processing unit (image processing unit having a desired structure) for carrying out the desired image processing and execution of image processing by the constructed image processing unit. As a result, even if arbitrary devices is newly developed, for carrying out the desired image processing, a program for carrying out the image processing can be developed simply by developing the application 32 for making use of the interface to cause the image processing program group 34 to carry out the image processing required in the device. Thus, since it is not necessary to newly develop a program, the burden of development can be reduced.

Further, as described above, the image processing apparatus realized by the image processing program group 34 follows the construction instruction from the application 32, constructs the image processing unit for carrying out image processing instructed by the application 32, and carries out the image processing by the constructed image processing unit. Accordingly even if, for example, image data to be subjected to image processing has an indeterminate color space and an indeterminate number of bits per unit pixel, and even if image processing to be carried out has indeterminate contents and indeterminate procedures/parameters, image processing carried out by the image processing apparatus (image processing unit) can be flexibly changed according to the image data to be processed and the like by the application 32 instructing the reconstruction of the image processing unit.

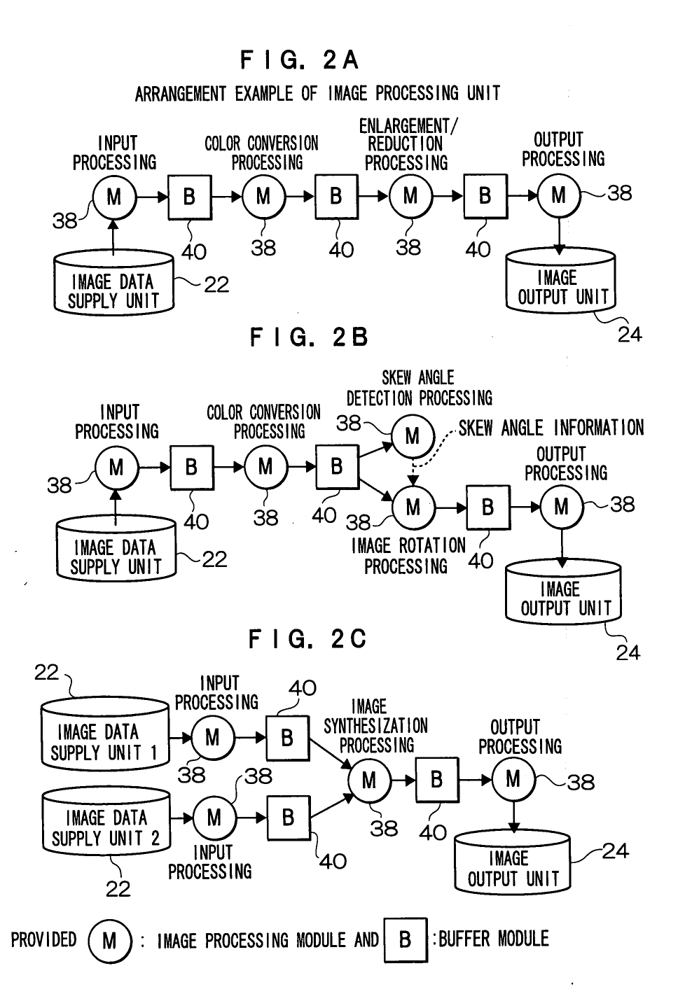

The image processing program group 34 will be explained below. As shown in FIG. 1, the image processing program group 34 is broadly divided into a module library 36, a program of a processing construction unit 42, and a program of a processing management unit 46. Although described in detail later, the processing construction unit 42 according to the embodiment constructs, based on an instruction from an application, an image processing unit 50 composed of one or more image processing modules 38 performing predetermined image processing and a buffer module 40 including a buffer provided at a proceeding or following stage of each of the image processing modules 38 to store image data, wherein the image processing modules 38 and the buffer module 40 are coupled with each other in the form of a pipeline form or a directed acyclic graph (DAG), as shown in FIGS. 2A to 2C as an example. Each image processing module constituting the image processing unit 50 is in an entity of a first program, executed by the CPU 12 for causing the CPU 12 to carry out predetermined image processing, or a second program, executed by the CPU 12 for instructing the CPU 12 to carry out processing to an external image processing apparatus (for example, a dedicated image processing board and the like) that is not shown in FIG. 1. Plural types of programs of the image processing module 38 are registered in the module library 36 described above to carry out predetermined image processing that are different from each other (for example, input processing, filter processing, color conversion processing, enlargement/reduction processing, skew angle detection processing, image rotation processing, image synthesization processing, output processing, and the like). To simplify explanation, it is assumed below that each image processing module constituting the image processing unit 50 is an entity of the first program.

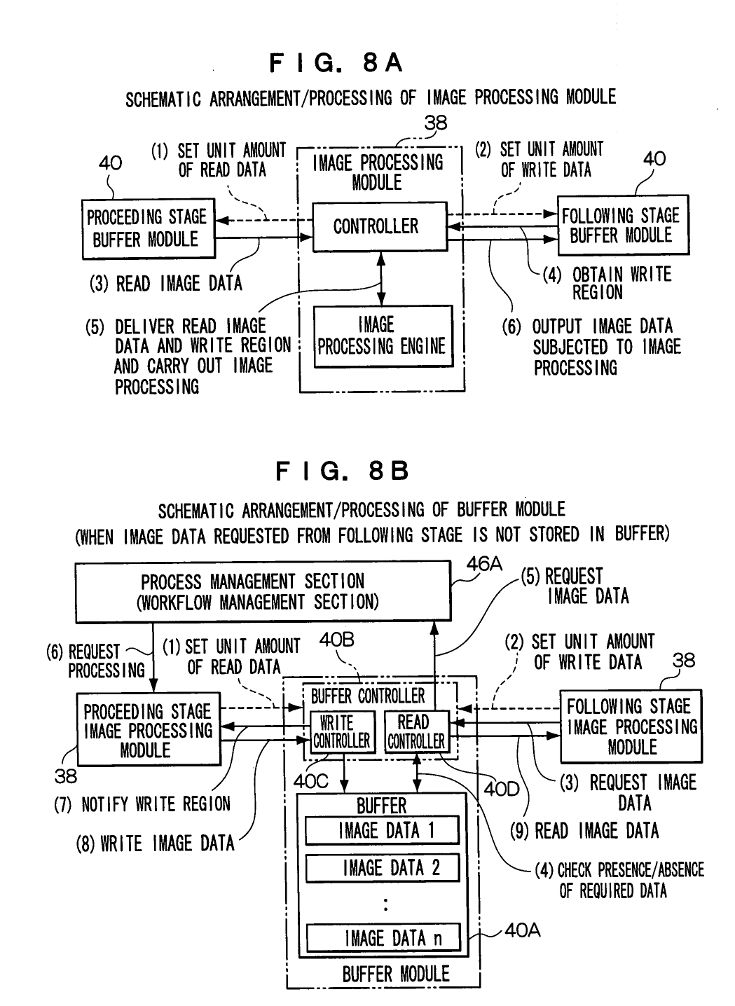

As shown also in FIG. 8A as an example, each image processing module 38 is composed of an image processing engine 38A for carrying out image processing to image data of a predetermined unit amount of processing data and a controller 38B for controlling input and output of image data to and from the modules at the proceeding and the following stages of the image processing module 38 and controlling the image processing engine 38A. A unit amount of processing data in each image processing module 38 is previously set by being selected from an arbitrary number of bytes including one line of image, plural lines of image, one pixel of image, one sheet of image, and the like, according to a type and the like of image processing carried out by the image processing engine 38A. For example, the unit amount of processing data is set to one pixel in an image processing module 38 for carrying out color conversion processing and filter processing, to one or plural lines of image in an image processing module 38 for carrying out enlargement/reduction processing, to one sheet of image in an image processing module 38 for carrying out image rotation processing, and to N Bytes depending on the execution environment in an image processing module 38 for carrying out image compression/stretch processing.

Further, image processing modules 38, each composed of an image processing engine 38A for carrying out the same type of image processing on different contents, are also registered to the module library 36 (in FIG. 1, this type of image processing module is shows as “module 1” and “module 2”). As to, for example, in an image processing module 38 for carrying out the enlargement/reduction processing, there are provided plural image processing modules 38, such as an image processing module 38 for carrying out a 50% reduction in processing with respect to input image data by thinning out every other pixel, an image processing module 38 for carrying out the enlargement/reduction processing with respect to input image data at a designated enlargement/reduction ratio, and the like. Further, as to, for example, the image processing module 38 for carrying out the color conversion processing, there are prepared an image processing module 38 for converting an RGB color space into a CMY color space, an image processing module 38 for converting a CMY color space into an RGB color space, and an image processing module 38 for carrying out other color space conversions such as an L*a*b*color space.

Further, in order to input image data necessary to process it by the image processing engine 38A in the unit amount of processing data, the controller 38B of the image processing module 38 obtains image data from a module (for example, a buffer module 40) at the proceeding stage of the module itself in a unit amount of write data and outputs image data output from the image processing engine 38A to a module (for example, a buffer module 40) at the following stage of it in a unit amount of write data (unless image processing such as compression, by which an amount of data is increased or reduced, is carried out by the image processing engine 38A, the unit amount of write data=the unit amount of processing data). The image processing engine 38A also carries out processing for outputting a result of image processing to the outside of the module itself, or for outputting a result of the image processing carried out by the image processing engine 38A to the outside of the module itself (when, for example, the image processing engine 38A carries out image analyzing processing and the like, such as the skew angle detection processing, a result of image analysis such as a result of skew angle detection may be output in place of the image data). To cope with such a case, image processing modules 38 each composed of an image processing engine 38A for carrying out the same type of image processings having the same contents but different unit amounts of processing data, read data, and write data are also registered to the module library 36. For example, although the unit amount of processing data in the image processing module 38 for carrying out the image rotation processing is the one sheet of image in the above description, the module library 36 may include image processing modules 38 which carry out the same image rotation processing but in which the unit amount of processing data is a single line or plural lines of image.

Further, the program of each image processing module 38 registered to the module library 36 is composed of a program corresponding to the image processing engine 38A and a program corresponding to the controller 38B, and the program corresponding to the controller 38B is arranged as a part. In the respective image processing modules 38, the program, which corresponds to the controller 38B, of the image processing modules 38 having the same unit amount of read data and the same unit amount of write data is arranged as a common program regardless of the type and the contents of image processing carried out by the image processing engine 38A (the same program is used as the program corresponding to the controller 38B). With this arrangement, the burden of development for developing the program of the image processing module 38 can be reduced.

Note that, in some of the image processing modules 38, the unit amount of read data and the unit amount of write data are not fixed because the attribute of an input image is unknown and thus they are set by obtaining the attribute of the input image and carrying out an arithmetic operation by substituting the obtained attribute in a predetermined arithmetic operation formula. In this type of the image processing modules 38, a common program may be employed corresponding to the controller 38B to the image processing modules 38 whose unit amounts of read data and write data can be derived using the same arithmetic operation formula. Further, although the image processing program group 34 according to the embodiment can be mounted on the various types of the devices as described above, it is needless to say that the number, the type, and the like of the image processing module 38 registered to the module library 36 in the image processing program group 34 can be appropriately added, deleted, replaced according to image processing required by the various types of the devices on which the image processing program group 34 is mounted.

Further, as shown also in FIG. 8B as an example, each buffer module 40 constituting the image processing unit 50 is composed of a buffer 40A and a buffer controller 40B. The buffer 40A is composed of a memory region secured from the memory 14 provided in the computer 10 through the operating system 30, and the buffer controller 40B inputs and outputs image data to and from the modules at the proceeding and the following stages of the buffer module 40 and manages the buffer 40. Further, the buffer controller 40B includes a write controller 40C and a read controller 40D. In each buffer module 40, the write controller 40C and the read controller 40D of the buffer controller 40B are also programs executed by the CPU 12, and a program of the buffer controller 40B is also registered to the module library 36 (in FIG. 1, the program of the buffer controller 40B is shown as “buffer module”).

Further, as shown in FIG. 1, the processing construction unit 42 for constructing the image processing unit 50 according to an instruction from the application 32 is composed of plural module generation units 44. The plural module generation units 44 correspond to image processing different from each other and are started by the application 32. Accordingly, the module generation units 44 carries out processing for creating a module group composed of the image processing module 38 and the buffer module 40 for realizing the corresponding image processing. Note that FIG. 1 shows, as an example of the module generation unit 44, a module generation unit 44 corresponding to a type of image processing carried out by each image processing modules 38 registered to the module library 36. However, image processing corresponding to each module generation unit 44 may be image processing realized by plural types of the image processing modules 38 (for example, skew correction processing composed of the skew angle detection processing and the image rotation processing). When necessary image processing is processing composed of a combination of plural types of image processings, the application 32 sequentially starts module generation units 44 corresponding to any of the plural types of the combined image processings. With this operation, an image processing unit 50 for carrying out the necessary image processing is constructed by the module generation units 44 sequentially started by the application 32.

Further, as shown in FIG. 1, the processing management unit 46 includes a work flow management unit 46A for controlling execution of image processing in the image processing unit 50, a resource management unit 46B for managing resources of the computer 10 such as the memory 14, and various types of files, used by the respective modules of the image processing unit 50, and an error management unit 46C for managing an error occurring in the image processing unit 50. Note that in the embodiment, the image processing unit 50 constructed by the processing construction unit 42 operates such that each image processing module 38 constituting the image processing unit 50 operates so as to carry out image processings in parallel while delivering image data to a following stage in a unit of an amount of data smaller than one sheet of image (referred to as a block unit processing).

Note that as a memory management system carried out by the resource management unit 46B any one of the following may be employed, for example, a first management system for securing a memory region to be allocated to a module of a request source from the memory 14 through the operating system 30 each time a request is issued from the respective modules of the image processing unit 50, a second management system for previously securing a memory region with a predetermined size from the memory 14 through the operating system 30 (for example, when the computer 10 is energized), and allocating a part of the previously secured memory region to the module of the request source when a request is issued from the respective modules, and a third management system for previously securing a memory region with a predetermined size from the memory 14 through the operating system 30, allocating, when a request is issued from the respective modules, a part of the previously secured memory region to the module of the request source if the size of the required memory region is less than a threshold value, and securing a memory region to be allocated to the module of the request source through the operating system 30 if the size of the required memory region is equal to or larger than the threshold value. Further, a management system for executing memory management may be selected from the above management systems.

Further, when an error occurs while the image processing unit 50 carries out image processing, the error management unit 46C carries out processing for obtaining error information such as a type and a location of occurrence of the occurred error, obtaining apparatus environment information showing a type, and an arrangement of devices to which the computer 10 having the image processing program group 34 installed thereon is assembled from the storage unit 20 and the like, determining an error notification method according to an apparatus environment shown by the obtained apparatus environment information, and notifying occurrence of the error by the thus determined error notification method.

Next, operation of the embodiment will be explained. When there occurs a status in which any image process must be carried out in devices on which the image processing program group 34 is installed, the status is detected by a particular application 32. The status, in which the image processing must be carried out, occurs when a user instructs to carry out a job for reading an image by the image reading unit as the image data supply unit 22 and recording the image on a recording material by the image recording unit as the image output unit 24, a job for displaying an image on the display unit as the image output unit 24, a job for writing image data to the recording medium by the write unit as the image output unit 24, and a job for transmitting image data by the transmission unit as the image output unit 24. Further, the status also occurs when the user instructs to carry out a job for storing image data to the image storage unit as the image output unit 24, when image data is received by the receiving unit as the data supply unit 22, and when the user instructs to carry out jobs for recording the image data stored in the image storage unit as the image data supply unit 22 to the recording material, displaying the image data on the display unit, writing it to the recording medium, transmitting of it, and storing it to the image storage unit. Further, the status, in which the image processing must be carried out, is not limited to the above cases and may be a case in which the user selects processing of a target to be carried in a status that the application 32 displays a list of names and the like of processings that can be carried out on the display unit 16 in response to an instruction from the user.

When the status in which any processing must be carried out is detected, as above, the application 32 first recognizes the type of the image data supply unit 22 for supplying image data to be subjected to image processing. When the recognized type is a buffer region (a partial region of the memory 14), a parameter is set to cause the buffer controller 40B to recognize the buffer region designated as the image data supply unit 22 as the already secured buffer 40A, and a process, a thread or an object is generated to carry out the program of the buffer controller 40B (the buffer controller 40B is generated), thereby the buffer module 40 (the buffer module 40 that acts as the image data supply unit 22) including the designated buffer region is generated.

Subsequently, the application 32 recognizes a type of the image output unit 24 as a destination to which the image data subjected to the image processing is output in the same way as above. When the recognized type is a buffer region (a part of the memory 14), the buffer module 40 including the buffer region designated as the image output unit 24 is generated likewise the above. The buffer module 40 generated here acts as the image output unit 24. Further, the application 32 recognizes the contents of the image processing to be carried out, decomposes the image processing to be carried out to a combination of image processings of a level corresponding to the respective module generation units 44, and determines a type of image processing necessary to realize the image processing to be carried out and a sequence for carrying out the respective image processings. Note that the determination can be realized in, for example, such a manner that the user previously registers the type of the image processing and a sequence for carrying out the respective image processings as information while corresponding them to a type of jobs whose execution can be instructed by the user, and the application 32 reads information corresponding to the types of the jobs whose execution are instructed.

After the application 32 starts a module generation unit 44 corresponding to particular image processing (creates a process, a thread or an object for carrying out the program of the module generation unit 44) based on the type and the sequence of execution of the image processing determined above, the application 32 notifies the started module generation unit 44 of input module identification information for identifying an input module for inputting image data to the module group, output module identification information for identifying an output module from which the module group outputs image data, input image attribute information showing an attribute of input image data input to the module group as information necessary for the module generation unit 44 to create the module group, and a parameter of the image processing to be carried out, and instructs to create a corresponding module group. Further, in a case in which the necessary image processing is composed of a combination of plural types of image processings, when it is notified from the indicated module generation unit 44 that generation of the module group has been completed, the application 32 repeats processing for starting other module generation unit 44 corresponding to the respective image processings and notifying information necessary to create the module group in ascending order of an execution sequence of the respective image processings.

Note that, as to a module group to be carried out first, the image data supply unit 22 is used as the input module, and as to module groups to be carried out second and thereafter, a final module (ordinarily, a buffer module 40) of a module group at a proceeding stage is used as the input module. Further, as to the output module, since the image output unit 24 is used as an output module in a module group to be carried out last, the image output unit 24 is designated as the output module. However, since an output module is not fixed in other module groups, no output module is designated by the application 32, and thus the output module is generated and set by the module generation unit 44 when necessary. Further, the application 32 may recognize an attribute of an input image and a parameter of image processing in, for example, such a manner that the user previously registers them as information by corresponding them to a type of job whose execution can be instructed by the user and reads information corresponding to the type of a job whose execution is instructed. Otherwise, the user may designate the attribute of the input image and the parameter of the image processing.

When the module generation unit 44 is started by the application 32, it carries out module generation processing. In the module generation processing, first, input image attribute information, which shows an attribute of input image data input to an image processing module 38 as a target to be generated, is obtained. Note that, when a buffer module 40 exists at the proceeding stage of the image processing module 38 as the target to be generated, the processing for obtaining the attribute of the input image data can be realized by obtaining the attribute of an output image data from an image processing modules 38 in a proceeding stage which is located at the proceeding stage of the above proceeding stage and in which image data is written to the buffer module 40.

Then, whether or not it is necessary to create the image processing module 38 as the target to be generated is determined based on the attribute of the input image data shown by the obtained information. For example, when the module generation unit 44 is a module generation unit for creating a module group for carrying out color conversion processing and a CMY color space is designated as a color space of the output image data by the parameter of the image processing through the application 32, when it is found that the input image data is data of an RGB color space based on the obtained input image attribute information, it is necessary to create an image processing module 38 for carrying out color space conversion from RGB to CMY as an image processing module 38 for carrying out color space processing. However, when the input image data is data of the CMY color space, since the attribute of the input image data is in agreement with the attribute of the output image data as to a color space, it is determined that an image processing module 38 for carrying out color space conversion processing is not necessary.

When it is determined necessary to create the image processing module 38 as the target to be generated, it is determined whether or not a buffer module 40 is necessary at the following stage of the image processing module 38 as the target to be generated. The determination is No when the following stage of the image processing module is an output module (the image output unit 24) (refer to the image processing module 38 in the rearmost stage in the image processing unit 50 shown in, for example, FIGS. 2A to 2C) and when the image processing module is a module which carries out image processing such as analysis to image data and outputs a result of the processing to other image processing module 38 as in an image processing module 38 for carrying out skew angle detection processing in the image processing unit 50 shown as an example in FIG. 2B. The determination is Yes in the cases other than the above, and a buffer module 40 to be coupled with the following stage of the image processing module 38 is generated by starting the buffer controller 40B (creating a process, a thread or an object for carrying out the program of the buffer controller 40B).

Subsequently, since the information of a module (for example, the buffer module 40) at a proceeding stage, the information of a buffer module 40 at a following stage (only the image processing module 38 that creates the buffer module 40 to the following stage), the attribute of the input image data input to the image processing modules 38, and a processing parameter are given and registered to the module library 36, and an image processing module 38, which is in agreement with the attribute of the input image data previously obtained and with the processing parameter to be carried out by the image processing module 38, is selected and generated from plural candidate modules that can be used as the image processing module 38 (a process, a thread or an object for carrying out the programs of the image processing engine 38A and the controller 38B is generated).

When, for example, the module generation unit 44 is a module generation unit for creating a module group for carrying out the color conversion processing, the CMY color space is designated by the processing parameter as the color space of the output image data, and further the input image data is the data of the RGB color space, an image processing module 38 for carrying out the color space conversion from RGB to CMY is selected and generated from the plural types of the processing modules 38 for carrying out various types of color space processings registered to the module library 36. Further, when the image processing module is an image processing modules 38 for carrying out the enlargement/reduction processing and a designated enlargement/reduction ratio is other than 50%, an image processing module 38, which carries out reduction processing to the input image data at a designated enlargement/reduction ratio, is selected and generated. When the designated enlargement/reduction ratio is 50%, an image processing module 38, which carries out enlargement/reduction processing specialized in the enlargement/reduction ratio of 50%, that is, carries out reduction processing for reducing the input image data to 50% by thinning out every other pixel, is selected and generated.

Note that selection of the image processing module 38 is not limited to that described above. That is, for example, plural image processing modules 38 having a different unit amount of processing data in the image processing carried out by the image processing engine 38A may be registered to the module library 36, and an image processing module 38 having an appropriate unit amount of processing data may be selected according to an operation environment such as a size of a memory region that can be allocated to the image processing unit 50 (for example, an image processing module 38 whose unit amount of processing data is reduced in accordance with reduction of the size may be selected). Otherwise, the image processing module 38 may be selected by the application 32 or the user.

On completion of the generation of the image processing module 38, an ID set of the buffer module 40 at the following stage and the ID of the generated image processing module 38 is notified to the work flow management unit 46A. It is sufficient that the IDs be information by which respective modules can be uniquely discriminated. For example, they may be numbers assigned to the respective modules in an order of generation, the addresses of the objects of the buffer modules 40 and the image processing modules 38 on the memory, and the like. Further, when module generation unit 44 creates a module group for carrying out image processing realized by plural types of image processing modules 38 (for example, skew correction processing realized by an image processing module 38 for carrying out the skew angle detection processing and an image processing module 38 for carrying out the image rotation processing), the above processing is repeated and a module group including at least two image processing modules 38 is generated. An image processing unit 50 for carrying out necessary image processing is constructed, as an example, as shown in FIGS. 2A to 2C by sequentially carrying out the module generation processing by the respective module generation units 44 sequentially started by the application 32.

In the present embodiment, when a specific image processing is carried out frequently, even after an image processing unit 50 for carrying out the specific image processing is generated, the application 32 does not instruct ending of the processing to plural types of the module generation units 44 for creating the image processing unit 50 that carries out the specific image processing so that the module generation units 44 remain as processes, threads, or objects. Thus, each time it is necessary to carry out the specific image processing, the application 32 sequentially instructs the respective module generation units 44 remaining as processes, threads, or objects to create the module group, whereby it is possible to recreate the image processing unit 50 for carrying out the specific image processing. With this operation, processing for starting the corresponding module generation units 44 each time it is required to carry out the specific image processing becomes unnecessary, and thus the time necessary to recreate the image processing unit 50 for carrying out the specific image processing can be reduced.

The controller 38B of the image processing modules 38 carries out initialization of the image processing modules 38 when it is started by the module generation unit 44. In the initialization, first, there is stored the information of the modules at the proceeding and the following stages of the module itself given from the module generation unit 44. Next, the size of a memory used by the module itself and presence or absence of other resource used by the module itself are recognized based on the type, the contents, and the like of image processing carried out by the image processing engine 38A of the module itself. The memory used by the module itself is mainly a memory that is necessary for the image processing engine 38A to carry out image processing. However, when a module at a proceeding stage is the image data supply unit 22 and when a module at a following stage is the image output unit 24, a buffer memory may be necessary to temporarily store image data to transmit and receive image data to and from the module at the proceeding stage or the following stage. Further, when the processing parameter includes information such as a table and the like, a memory region for storing it may be necessary. Then, securing a memory region having a recognized size is requested to the resource management unit 46B, and the memory region secured by the resource management unit 46B is received therefrom. Further, when it is recognized that the image processing engine 38A of the module itself requires a resource other than the memory, the resource management unit 46B is requested to secure the other resource, and the other resource is received from the resource management unit 46B.

Subsequently, a module at the proceeding stage of the module itself is determined. When no module exists at the proceeding stage of the module itself, no processing is carried out. However, when the module at the proceeding stage is, for example, an image data supply unit 22, a specific file, and the like other than a buffer module 40, initialization processing is carried out as necessary. Further, when a buffer module 40 exits at the proceeding stage of the module itself, the amount of image data (unit amount of read data) obtained from the buffer module 40 at the proceeding stage by reading image data once is recognized. When the number of the buffer modules 40 at the proceeding stage of the module itself is one, the unit amount of read data is only one. However, when there are plural the buffer modules 40 at the proceeding stage as in the image processing module 38 for carrying out image synthesization in the image processing unit 50 shown in for example, FIG. 2C and the image processing engine 38A carries out image processing using image data obtained from the plural buffer modules 40, the unit amounts of read data corresponding to the respective buffer modules 40 at the proceeding stage are determined depending on the type and the contents of image processing carried out by the image processing engine 38A of the module itself, the number of the buffer modules 40 at the proceeding stage, and the like. Then, the recognized unit amounts of read data are set to all the buffer modules 40 existing in the proceeding stage by notifying them to all the buffer modules 40 existing in the proceeding stage (refer also to (1) of FIG. 8A).

Next, a module at the following stage of the module itself is determined. When the module at the following stage of the module itself is, for example, an image output unit 24, a specific file, and the like other than the buffer module 40, initialization processing (for example, when the module at the following stage is an image output unit 24, processing for notifying that image data is output in an amount corresponding to the unit amount of write data, and the like) is carried out as necessary. Further, when the module at the following stage is a buffer module 40, the amount of image data (unit amount of write data) when the image data is written once is recognized, and the unit amount of write data is set to the buffer module at the following stage (refer also to (2) of FIG. 8A). Then, the processing is finished by notifying the module generation unit 44 of the completion of initialization of the image processing module 38.

On the other hand, when the buffer controllers 40B of the respective buffer modules 40 constituting the image processing unit 50 are started by the module generation unit 44 or the application 32, the buffer modules 40 are initialized. In the initialization of the buffer module 40, first, each time the unit amount of write data is notified from the image processing module 38 at the proceeding stage of the module itself or each time the unit amount of read data is notified from the image processing module 38 at the following stage of the module itself, the notified unit amount of write data or unit read data is stored (refer also to (1), (2) FIG. 8B).

When the unit amounts of write data or read data are notified from all the image processing modules 38 coupled with the module itself, the size of a unit buffer region, which is a unit of management of the buffer 40A of the module itself is, determined based on the unit amounts of write data and read data set respectively by the respective image processing modules 38 coupled with the module itself, and the determined size of the unit buffer region is stored. The maximum values of the unit amounts of write data and read data set to the module itself can be appropriately set as the size of the unit buffer region. However, the unit amount of write data may be set, and the unit amount of read data (when plural image processing modules 38 are coupled with the following stage of the module itself, the maximum value of the unit amounts of read data set by the respective image processing modules 38) may be set. Further, the least common multiple of the (maximum values) of the unit amounts of write data and read data may be set. When the least common multiple is less than a predetermined value, the least common multiple may be set, and when least common multiple is equal to or larger than the predetermined value, a different value (for example, any of the maximum value of the unit amount of write data and the unit amount of read data described above and (the maximum value) of the unit amount of write data, the unit amount of read data) may be set.

Further, when the module itself is generated by the application 32 and is a buffer module 40 acting as the image data supply unit 22 or the image output unit 24, since a memory region used as the buffer 40A of the module itself already exists, the size of the unit buffer region determined previously is changed to the size of the existing memory region used as the buffer 40A of the module itself. Further, available data pointers corresponding to the respective image processing modules 38 at the following stage of the module itself are generated, respectively, and the generated available data pointers are initialized. The available data pointers are pointers for indicating the leading head position (next read start position) and the trailing position of image data (available data), which is not read by the image processing module 38 of a corresponding following stage, of the image data written to the buffer 40A of the module itself by the image processing module at the proceeding stage of the module itself, and specific information that means that no available data exists is ordinarily set in initialization. However, when the module itself is generated by the application 32 and is the buffer module 40 acting as a image data supply unit 22, image data to be subjected to image processing may be already written to the memory region used as the buffer 40A of the module itself. In this case, the leading head position and the trailing position of the image data are set to the available data pointers corresponding to the respective image processing modules 38 at the following stage, respectively.

Further, a “detection flag” used in data write processing carried out by the write controller 40C of the buffer controller 40B is initially set to 1, and a “compression flag” and a “number of input times” are initially set to 0, respectively. Initialization of the buffer controller 40B is completed by the above processing, and the buffer controller 40B notifies the work flow management unit 46A of the completion of initialization.

On the other hand, when the construction of the image processing unit 50 for carrying out necessary image processing is completed by sequentially carrying out the module generation processing described above by the module generation units 44 started sequentially, the application 32 instructs execution of image processing by the image processing unit 50 to the work flow management unit 46A by starting a thread (or a process or an object) for carrying out the program of the work flow management unit 46A.

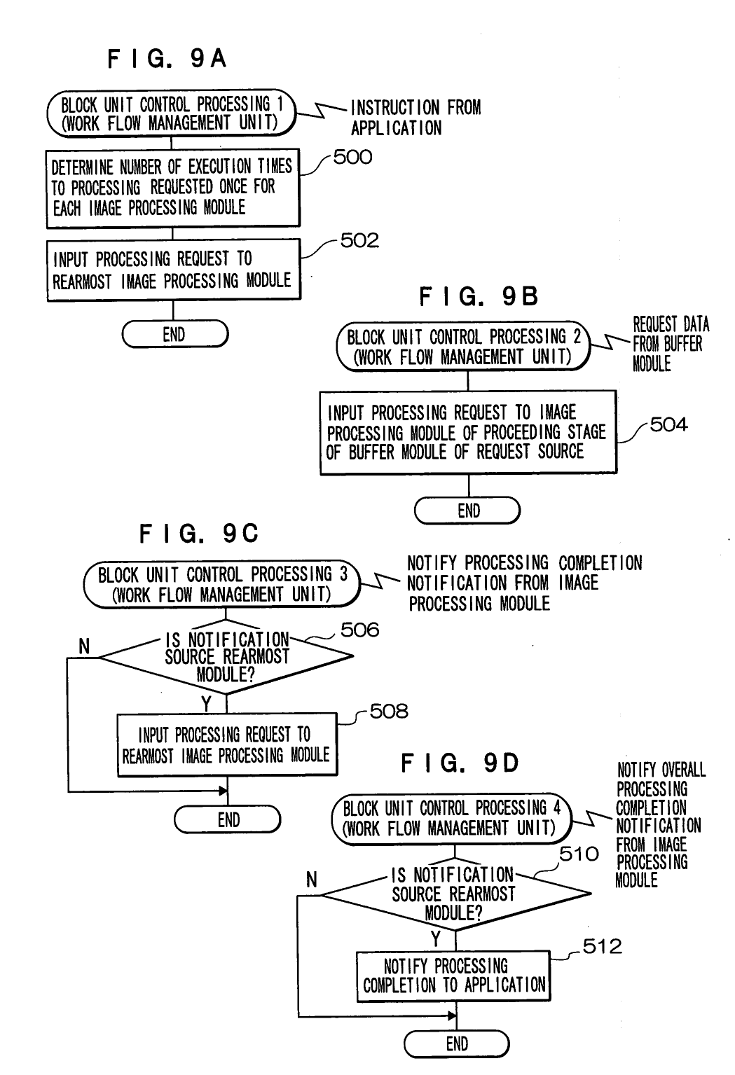

When program is started, the work flow management unit 46A of the processing management unit 46 carries out block unit control processing shown in FIG. 9. In the block unit processing, the work flow management unit 46A causes the image processing unit 50 to carry out image processing in a block unit execution mode by inputting a processing request to a predetermined image processing module 38 among the image processing modules 38 constituting the image processing unit 50. In the following explanation, however, processing carried out after the completion of initialization processing carried out by buffer controllers 40B of the respective buffer modules 40 and image processing module control processing carried out by the controllers 38B of the respective image processing modules 38 will be sequentially explained prior to explanation of overall operation of the image processing unit 50.

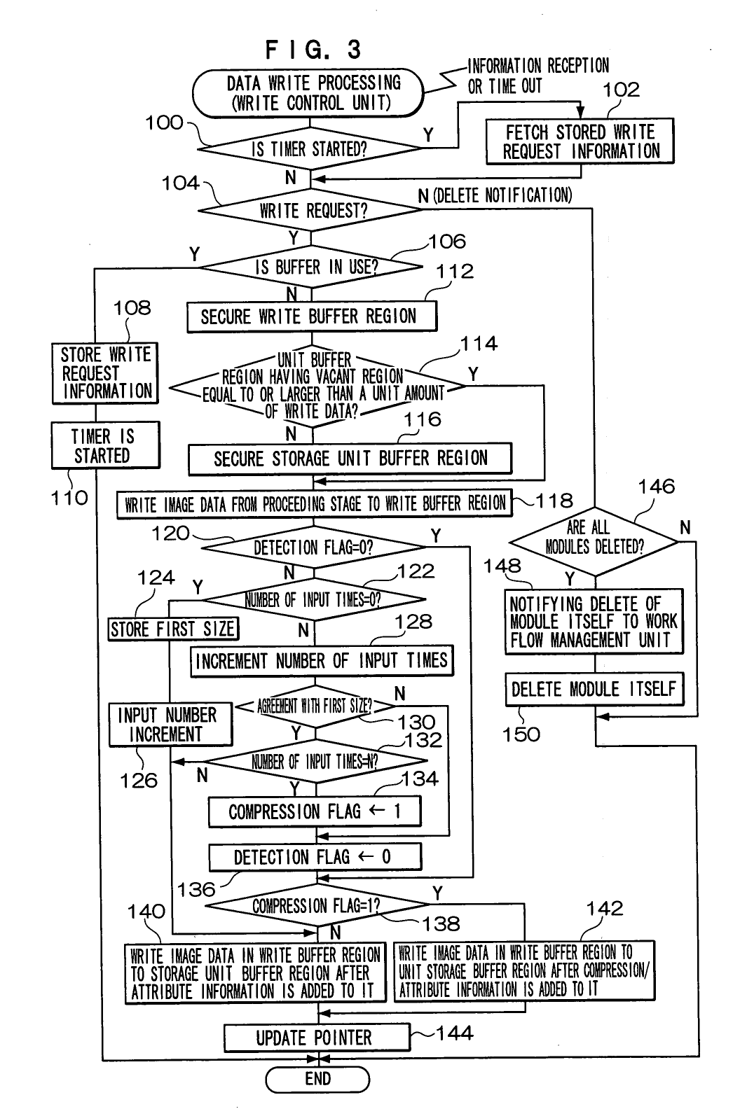

In the present embodiment, when the image processing module 38 writes image data to the buffer module 40 at the following stage, a write request is input from the image processing module 38 to the buffer module 40. When the image processing module 38 reads image data from the buffer module 40 at the proceeding stage, a read request is input from the image processing module 38 to the buffer module 40. When any information including the write request from the image processing module 38 at the proceeding stage is input to the buffer controller 40B (and when a timer to be described below is time out), data writing processing shown in FIG. 3 is carried out by the write controller 40C of the buffer controller 40B. Note that the data write processing described below may be started by calling a function or a method. The write controller 40C for carrying out the data write processing corresponds to a write means according to the present invention (more specifically, it corresponds to a write means according to a modification of a second aspect of the present invention).

In the data writing processing, first, at step 100, it is determined whether or not the data write processing is started by whether the timer is at time out or not. When the determination is No, the process goes to step 104, whereas when the determination is Yes, the process goes to step 102 at which write request information input in past and stored in the memory and the like is fetched therefrom. At step 104, it is determined whether or not information to be processed (information input to the buffer module 40 or information fetched from the work memory and the like) of a target to be processed is the write request information. When the determination is Yes, the process goes to step 106 at which it is determined whether or not the buffer 40A of the module itself is being used by other process, thread or object. Since the buffer 40A is also accessed from the read controller 40D, when the determination is Yes, the process goes to step 108 at which the write request information of the target to be processed is stored to the work memory and the like, and the data write processing is finished once by starting the timer at next step 110.

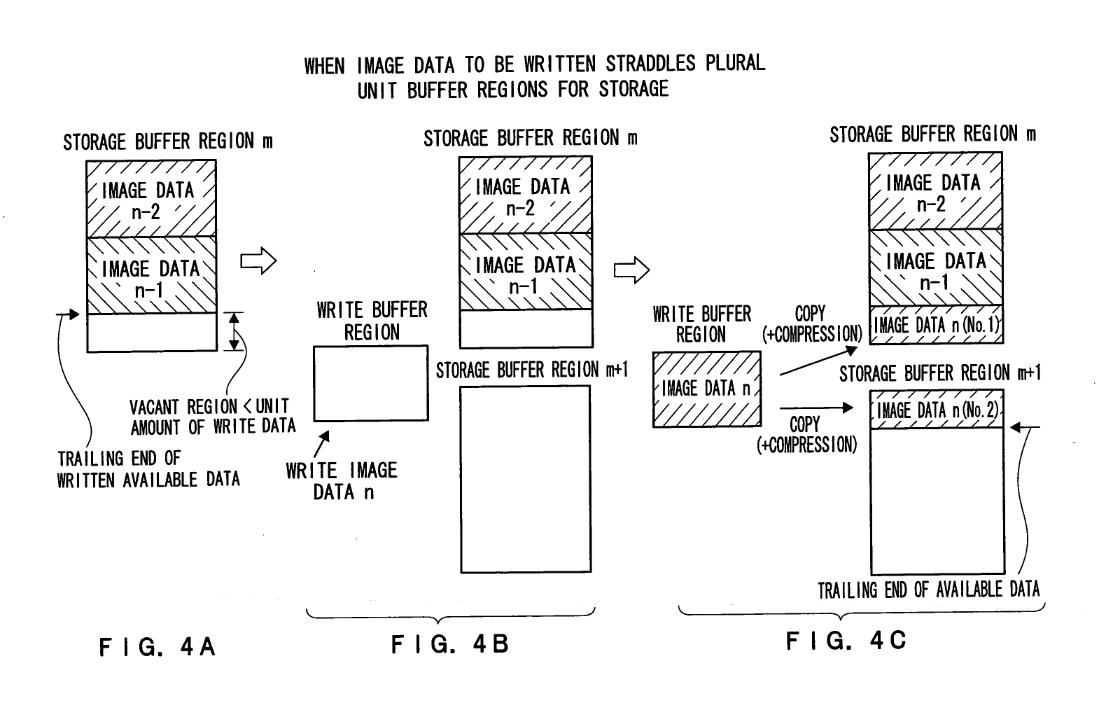

On the other hand, when the determination at step 106 is No, the process goes to step 112 at which the unit amount of write data is notified to the resource management unit 46B as the size of the memory region to be secured, and a memory region to be used for writing is secured by the resource management unit 46B (write buffer region: refer also to FIG. 4B). Next, at next step 114, it is determined whether or not a unit buffer region (unit buffer region to which image data of the unit amount of write data can be written) having a vacant region equal to or larger than the unit amount of write data exists in the storage unit buffer regions constituting the buffer 40A of the module itself. At first, the buffer module 40 generated by the module generation unit 44 does not secure a memory region (unit buffer region) to be used as the buffer 40A, and a unit buffer region is secured as a unit each time the memory region lacks. Accordingly, when the write request is input first to the buffer module 40, since a memory region (unit buffer region) to be used as the buffer 40A does not exist, the determination is No. Further, even after the unit buffer region used as the buffer 40A is secured via processing described later, when the vacant region in the unit buffer region is made less than the unit amount of write data by the image data written to the unit buffer region, the above determination is No.

When the determination at step 114 is No, the process goes to step 116 at which it notifies the size of the memory region (the size of the unit buffer region) to be secured to the resource management unit 46B, causes the resource management unit 46B to secure memory region (unit buffer region used to store memory data) to be used as the buffer 40A of the module itself, and then moves to step 118. Further, when the determination at step 114 is Yes, the process goes to step 116 skipping step 116. At step 118, the process uses the write buffer region secured at step 112 as a write region, and notifies the leading head address of the write region to the image processing module 38 of a write request source as well as requests to write the image data to be processed sequentially from the notified leading head address. With this operation, image processing module 38 of the write request source writes the image data to the write region (the unit buffer region or the write buffer region) whose leading head address is notified (refer also to FIG. 4B).

When, for example, the size of the unit buffer region is not an integral multiple of the unit amount of write data, since image data of the unit amount of write data is repeatedly written to the buffer 40A (unit buffer region), a status that the size of the vacant region of the unit buffer region with the vacant region is smaller than the unit amount of write data occurs as shown also in FIG. 4A as an example. In this case, the region in which the image data of the unit amount of write data straddles plural unit buffer regions. In the embodiment, however, since the memory region used as the buffer 40A is secured using the unit buffer region as a unit, it is guaranteed that unit buffer regions secured at a different timing are regions continuous on an actual memory (the memory 14). In contrast, in the embodiment, the image processing module 38 writes image data to the write buffer region secured separately from the storage unit buffer region, and the image data written to the write buffer region once is copied to a single or plural unit write regions as shown in FIG. 4C. Accordingly, the write region is notified to the image processing module 38 of the write request source only by notifying the leading head address of the write region as described above regardless whether or not the region to which the image data is written straddles the plural unit buffer regions, thereby interface to the image processing module 38 is simplified.

It should be noted that when the module itself is the buffer module 40 generated by the application 32, that is, when a memory region used as the buffer 40A is already secured, the process goes to step 118 skipping steps 112 to step 116 described above and notifies the address of the already secured memory region to the image processing module 38 as the address of the write region, and writes the image data to the memory region.

On completion of writing of the image data to the write region by the image processing module 38, the process goes to step 124 at which it determines whether or not the detection flag is 0. Since the detection flag is a flag for showing whether or not compression/non-compression is detected to the image data written to the write region and the detection flag is initially set to 1 as described above, the determination is No at the time, and the process goes to step 116 at which it determines whether or not the number of input times is 0. Since the number of input times is information showing the number of times the image data is input from generation of the buffer module 40 up to the present time, and 0 is initially set to it, the determination at the time is Yes. Thus, the process goes to step 124 at which the size of the image data written to the write region by the image processing module 38 at the proceeding stage is detected, and the detected size is stored to the work memory and the like as an initial size.

After the number of input times is incremented by 1 at next step 126, the process goes to step 140 at which after attribute information is added to the image data written to the write buffer region, the image data is written to the storage buffer region as it is. Note that used as the attribute information are the compression flag showing whether or not the image data is compressed by the buffer module 40, the size of the image data, and the like. At step 140, 0 (non-compression) is set as the compression flag as well as the attribute information, to which the size detected previously is set, can be added to the image data as the size of the image data.

At step 144, a pointer showing the trailing position of the available data among the available data pointers corresponding to the respective image processing modules 38 at the following stage of the module itself is updated so that the trailing position of the available data shown by the pointer is moved backward by the unit amount of write data (refer also to FIG. 4C) as well as the memory region previously secured as the write buffer region is released by the resource management unit 46B, thereby the data write processing is finished once. Note that the write buffer region may be secured when the buffer module 40 is initialized and released when the buffer module 40 is deleted.

The data writing processing is carried out each time the write request is input from the image processing module 38 at the proceeding stage. However, after the write request is input from the image processing module 38 at the proceeding stage first, since the number of input times is set to a value equal to or larger than 1, the determination at step 122 is No, and the process goes to step 128 at which it increments the number of input times by only 1. Further, at step 130, the size of the image data written to the written region by the image processing module 38 at the proceeding stage is detected, and it is determined whether or not the detected size is in agreement with the initial size stored in the work memory and the like. When the determination is Yes, the process goes to step 132 at which it determines whether or not the number of input times reaches a predetermined value N. When the determination is No, the process goes to step 140 at which it carries out processing for adding the attribute information including the compression flag, to which the value 0 (non-compression) is set, and the size of the image data to the image data written to the write buffer region as described above and thereafter writing the image data to the storage buffer region as it is. Note that when the size of the vacant region of the unit buffer region with the vacant region is smaller than the unit amount of write data, the image data written to the write buffer region is separately written to plural the storage unit buffer regions as shown in FIG. 4C.

When the size of the image data written to the write region is in agreement with the initial size every time while the write request is input from the image processing module 38 at the proceeding stage N+1 times, it can be determined that the image data written to the write region by the image processing module 38 at the proceeding stage is non-compressed image data. Accordingly, in the above case, when an N+1 th write request is input, since the determination at step 132 is Yes, 1 is set to the compression flag. Note that the compression flag is a flag showing whether or not compression processing is to be carried out to the image data written to the storage unit buffer region, and compression flag=1 means to carry out the compression processing, and the compression flag=0 means not to carry out the compression processing. Further, at step 136, 0 is set to the detection flag, and, at next step 138, it is determined whether or not the detection flag is 1.

When the determination is Yes, the process goes to step 142 at which the image data written to the write buffer region is compressed by a predetermined compression system, the attribute information, to which 1 (compression) is set as the compression flag as well as to which the size (size before compression) detected previously is set as the size of the image data, is added to the compressed image data, and the compressed image data, to which the attribute information is added, is stored to the storage buffer region. Note that, at step 142, the information showing the compression system applied when the image data is compressed may be also added as the attribute information. When 1 is set to the compression flag once, the compression flag is kept to 1 during a period of time until the buffer module 40 is deleted. Accordingly, all the image data output from the image processing module 38 at the proceeding stage (written to the write region) thereafter is written to the storage buffer region after it is compressed. Further, when 0 is set to the detection flag, the processings at steps 122 to 136 of the data writing processing carried out thereafter are skipped.

As described above, in the data writing processing according to the present embodiment, when the image data output from the image processing module 38 at the proceeding stage (written to the write region) is non-compressed image data, the image data is written to the storage buffer region after it is subjected to the compression processing. Accordingly, the memory region to be secured as the storage buffer region can be reduced as well as the time necessary to write and read the image data to and from the storage buffer region can also be reduced. Further, when compression of the image data written to the storage buffer region (and expansion of the image data read from storage buffer region) are carried out, a load is applied to the CPU 12 that carries out these processings. However, since the CPU 12 has a high operating speed as compared with an access speed to the memory and the like as the buffer region, and the like, and, in particular, when image data having a large size is handled, it is a bottle neck in the processing speed of the image processing unit 50 that the access speed to the memory and the like as the buffer region is not sufficient, reduction of the processing speed of the image processing unit 50 can be also avoided by compressing (and expanding) the image data.

Further, when image data having a size different from the initial size is input to the write region during a period of time until the write request is input from the image processing module 38 at the proceeding stage N+1 times, it can be determined that the image data written to the write region by the image processing module 38 at the proceeding stage is compressed image data. In this case, the determination at step 130 is No, the process goes to step 136 at which 0 is set to the detection flag, and then the process goes to step 138 (step 134 at which 1 is set to the compression flag is skipped). Accordingly, since the determination at step 138 is No, there is carried out, at step 140, processing for adding the attribute information including the compression flag, to which the value 0 (non-compression) is set, and the size of the image data to the image data written to the write buffer region and then writing the image data to the storage buffer region as it is. Therefore, when the image data output from the image processing module 38 at the proceeding stage is image data compressed already, the image data is written to the storage buffer region as it is.

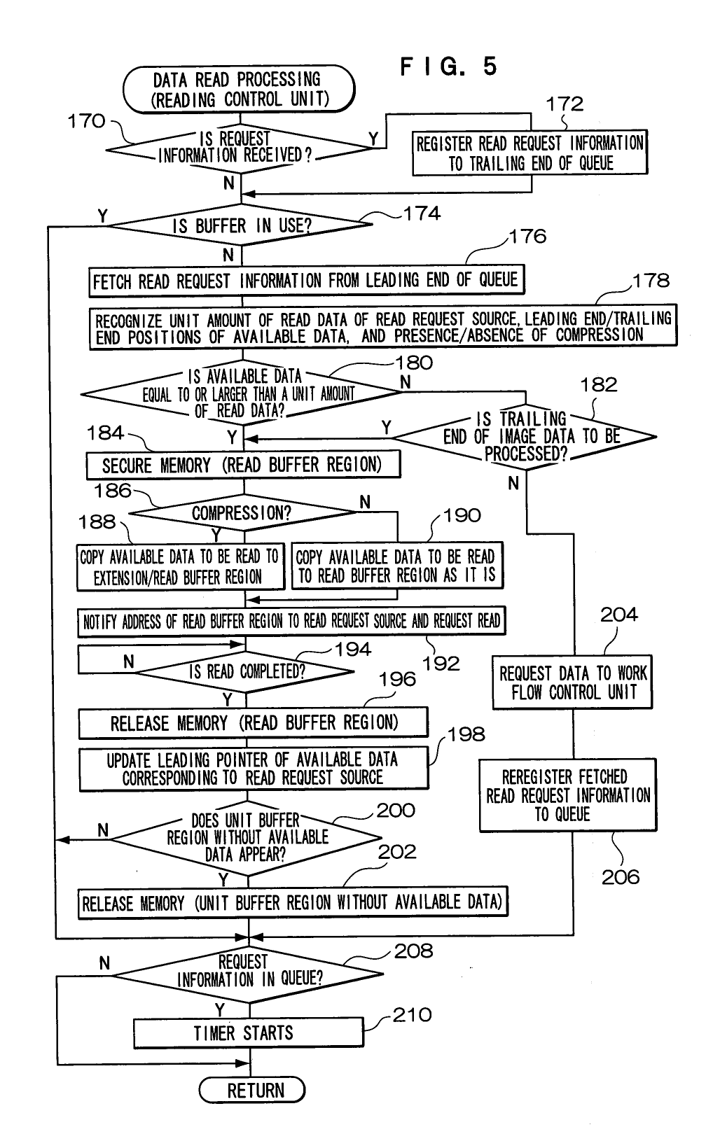

Subsequently, data reading processing, which is carried out by the read controller 40D of the buffer module 40 when the read request is input from the image processing module 38 at the following stage to the buffer module 40 (and when the timer described later is time out), will be explained with reference to FIG. 5. Note that the data write processing described below may be also started by calling the function and the method. Note that the write controller 40D for carrying out the data read processing corresponds to a read means according to the present invention (more specifically, it corresponds to a write means according to a modification of the second aspect of the present invention).

In the data reading processing, first, at step 170, it is determined whether or not the data reading processing in this time is started in response to the read request received from the image processing module at the following stage. When the determination is No, the process goes to step 174. However, when the determination is Yes, the process goes to step 174 at which the read request information received from the image processing module at the following stage this time is registered to the trailing end of a read queue. At step 174, it is determined whether or not the buffer 40A of the module itself is being used by another process, thread or object. Since the buffer 40A is accessed also from the write controller 40C, when the determination is Yes, the process goes to step 208 at which it is determined whether or not the read request information is registered to the read queue. When the determination is No, the data reading processing is finished, whereas when the determination is Yes, the timer is started at step 210, and the data reading processing is finished once. At the time the timer is started, when the timer is time out, the data reading processing is started again, an unprocessed reading request (information) registered to the read queue is retrieved again, and processing according to the read request is carried out.

On the other hand, when the determination at step 174 is No, the process goes to step 176 at which the read request information registered at the head of the read queue is fetched therefrom. At next step 178, the image processing module 38 of a read request source is recognized based on request source identification information included in the read request information fetched from the read queue and the unit amount of read data set by the image processing module 38 of the read request source is recognized as well as the queue head position (leading head) and the end position (trailing end) of available data corresponding to the image processing module 38 of the read request source on the buffer 40A, based on an available data pointer corresponding to the image processing module 38 of the read request source. At next step 180, it is determined whether or not the available data (image data that can be read by the image processing module 38 of the read request source) corresponding to the image processing module 38 of the read request source is equal to or larger than the unit amount of read data based on the leading head position and the trailing end position of the available data recognized at step 178.

Note that when the available data is image data compressed by the write controller 40C, the read controller 40D outputs the image data to the image processing module 38 of the read request source after it is subjected to expansion processing as described later. Accordingly, it is determined at the step 180 described above whether or not the available data is image data compressed by the write controller 40C referring to a compression flag in the attribute information added to the available data recognized at step 178. When the available data is the image data compressed by the write controller 40C, the size of the available data after compression is recognized referring to the size of the image data in the attribute information. Then, it is determined whether or not the recognized size is equal to or larger than the unit amount of read data.

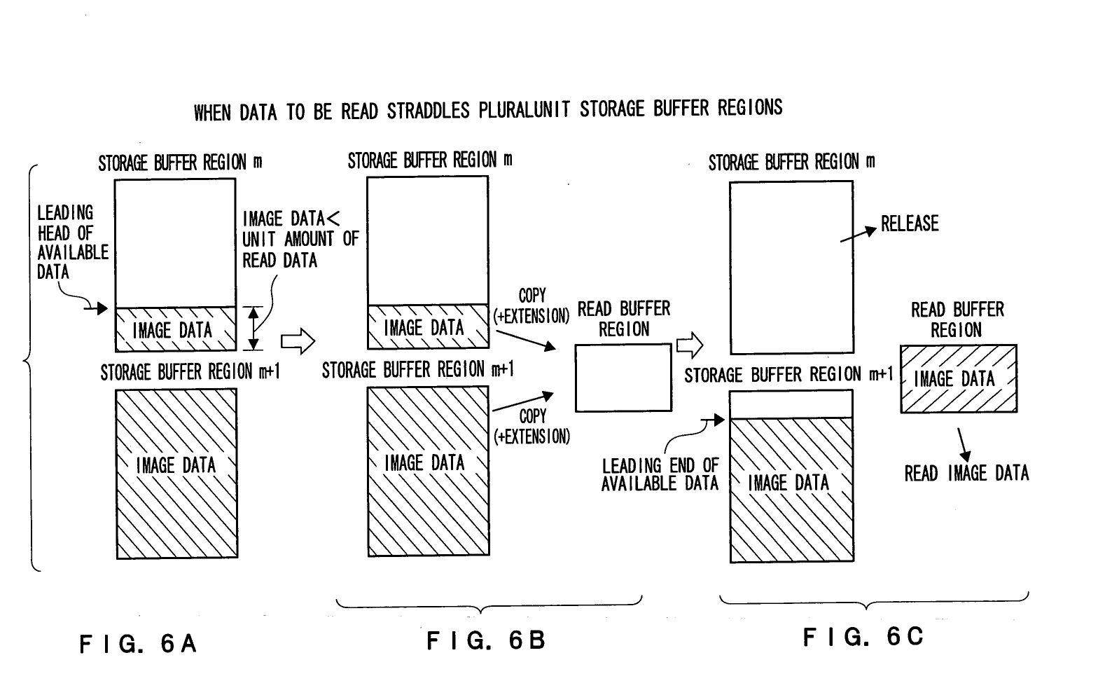

When the determination at step 180 is No, the process goes to step 182 at which it is determined whether or not the trailing end of the available data, which is stored in the buffer 40A and can be read by the image processing module 38 of the read request source, is the trailing end of the image data to be processed. When the trailing end of the available data is the trailing end of the image data to be processed although the available data corresponding to the image processing module 38 of the read request source is stored in the buffer 40A in an amount equal to or larger than the unit amount of read data or the available data corresponding to the image processing module 38 of the read request source and stored in the buffer 40A is less than the unit amount of read data, the determination at step 180 or 182 is Yes, and the process goes to step 184. At step 184, the unit amount of read data corresponding to the image processing module 38 of the read request source is notified to the resource management unit 46B as the size of the memory region to be secured as well as requesting to the resource management unit 46B to secure a memory region used for reading (read buffer region: refer also to FIG. 6B).

When the read buffer region is secured, it is determined at next step 186 whether or not the available data to be read is the image data compressed by the write controller 40C referring to (the compression flag) of the attribute information added to the available data to be read. When 1 is set to the compression flag of the attribute information added to the available data to be read, the above determination Yes, and the process goes to step 188. At step 188, the available data to be read is read from the buffer 40A in such a size that the size of the available data before compression corresponds to the unit amount of read data, the attribute information is removed from the read available data, the available data from which the attribute information is removed is subjected to the expansion processing so that the available data is returned to non-compressed image data as large as the unit amount of read data, and then the non-compressed image data is written to the read buffer region. Further, when 0 is set to the compression flag of the attribute information added to the available data to be read, the determination is No, and the process goes to step 190. At step 190, the available data to be read is read from the buffer 40A in the unit amount of read data, the attribute information is removed from the available data, and the available data from which the attribute information is removed is written to the read buffer region as it is.

At next step 192, the leading head address of the read buffer region is notified to the image processing module 38 of the read request source as the leading head address of the read region as well as it is requested to sequentially read image data from the notified leading head address. With this operation, the image processing module 38 of the read request source reads the image data from the read region (read buffer region) whose leading head address is notified. Note that when the available data to be read is data corresponding to the trailing end of the image data to be processed, it is also notified to the image processing module 38 of the read request source that the available data is the trailing end of the image data to be processed together with the size of the image data to be processed in a read request of the image data. Further, when the module itself is the buffer module 40 generated by the application 32, since the memory region (an aggregate of unit buffer regions) is a continuous region, it may be omitted to secure the read buffer region and to write the image data to be processed to the read buffer region, and the image processing module 38 at the following stage may directly read the image data from the unit buffer region.

When the image data to be read is the image data compressed by the write controller 40C as described above, the image data can be read by the image processing module 38 of the read request source after it is subjected to the expansion processing and written to the read buffer region. Accordingly, the image processing module 38 at the following stage of the buffer module 40 receives the same image data as that output from the image processing module 38 at the proceeding stage of the buffer module 40 (when the output image data is compressed image data, the compressed image data is received from the buffer module 40, whereas when the output image data is non-compressed image data, the non-compressed image data is received from the buffer module 40). As a result, since the respective image processing modules 38 need not switch processing depending on whether or not the buffer module 40 at the proceeding stage compresses image data, an arrangement of the image processing module 38 can avoid being complex by arranging the buffer module 40 such that when non-compressed image data is delivered thereto from the image processing module 38 at the proceeding stage, it subjects the image data to the compression/expansion processing, as described above.

Further, as shown in FIG. 6A as an example, when the amount of data of the available data stored in the unit buffer region, in which the image data of the leading head portion of the available data is stored, is less than the unit amount of read data and the available data to be read straddles plural the unit buffer regions, the available data to be read this time is not always stored in regions that are continuous on the actual memory (the memory 14). However, as shown in FIGS. 6B and 6C, in the data read processing, even in this case, the image data to be read can be read from the read buffer region after it is written to the read buffer region once. Accordingly, it is necessary only to notify the read request source of the leading head address to the read region the image processing module 38 as described above despite the image data to be read being stored to the plural unit buffer regions, thereby interface to the image processing module 38 can be simplified.

At next step 194, it is determined whether or not image data has been read from the read region by the image processing module 38 of the read request source, and step 194 is repeated until the determination becomes Yes. On receiving notification from image processing module 38 of the read request source notifying that the image data has been read, the determination at step 194 becomes Yes, and the process goes to step 196. At step 196, the leading head address and the size of a memory region secured as the read buffer region is notified to the resource management unit 46B, and the memory region is released by the resource management unit 46B. The read buffer region may be secured when the buffer module 40 is initialized and released when the buffer module 40 is deleted. Further, at step 198, among the available data pointers corresponding to the image processing module 38 of the read request source, a pointer showing the leading head position of the available data is updated by moving the leading head position of the available data rearward (refer also to FIG. 6C).

Further, at step 200, reference is made to the available data pointers corresponding to the respective image processing modules 38 at the following stage, and it is determined whether or not a unit buffer region in which the image data stored therein has been entirely read by the respective image processing modules 38 at the following stage, that is, a unit buffer region, in which no available data is stored, appears in the unit buffer regions constituting the buffer 40A due to the update of the pointer at step 198. When the determination is No, the process goes to step 208, and the data read processing is finished through steps 208 and 210 described above. However, when the determination is Yes, the process goes to step 202 at which the unit buffer region, in which no available data is stored, is released by the resource management unit 46B, then the process goes to step 208, and the data read processing is finished through steps 208 and 210.

On the other hand, when the amount of the available data, which is stored in the buffer 40A and can be read by the image processing module 38 of the read request source is less than the unit amount of read data as well as the trailing end of readable available data is not the trailing end of the image data to be processed (when no readable available data is detected in (4) of FIG. 8B), the determinations at steps 180,182 are No, and the process goes to step 204 at which a data request for requesting new image data is output to the work flow management unit 46A (refer also to (5) of FIG. 8B). In this case, a processing request is input to the image processing modules 38 at the proceeding stage of the module itself by the work flow management unit 46A. Further, at step 206, the read request information fetched from the read queue is registered again to (the leading end or the trailing end) of the original queue, and the data read processing is finished through steps 208 and 210. By this, the corresponding read request information is stored in the read queue and periodically the retreived requested processing is carried out for repeated trials during a period of time until the amount of the readable available data becomes equal to or larger than the unit amount of read data or it is detected that the trailing end of the readable available data is the trailing end of the image data to be processed (until the determination at step 180 or 182 becomes Yes).

Although described later in detail, when the data request is input from the buffer module 40, the work flow management unit 46A inputs a processing request to the image processing module 38 at the proceeding stage of the buffer module 40 of a data request source (refer also to (6) of FIG. 8B). When the image processing module 38 at the proceeding stage can write image data to the buffer module 40 by processing carried out by the controller 38B of image processing module 38 at the proceeding stage in response to the input processing request acting as a trigger, a write request is input from the image processing module 38 at the proceeding stage to thereby carry out the data write processing described above (FIG. 3), and thus the image data is written from the image processing module 38 at the proceeding stage to the buffer 40A of the buffer module 40 (refer also to (7) and (8) of FIG. 8B). By this, the image data is read from the buffer 40A by the image processing module 38 at the following stage (refer also to (9) of FIG. 8B).

In the data writing processing and the data reading processing described above, an exclusive control, in which while one of them accesses the buffer 40A of the module itself, the other of them stops access to the buffer module 40, is carried out. By this, even if the CPU 12 of the computer 10 carries out processes or threads corresponding to respective modules constituting the image processing unit 50 in parallel, since a disadvantage caused due to plural requests being input to a single buffer module 40 at the same time or at approximately the same time, the CPU 12 of the computer 10 can carry out the processes or the threads corresponding to the respective modules of the CPU 12 of the computer 10 in parallel. It is needless to say that the buffer module may be realized as an ordinary program or object.

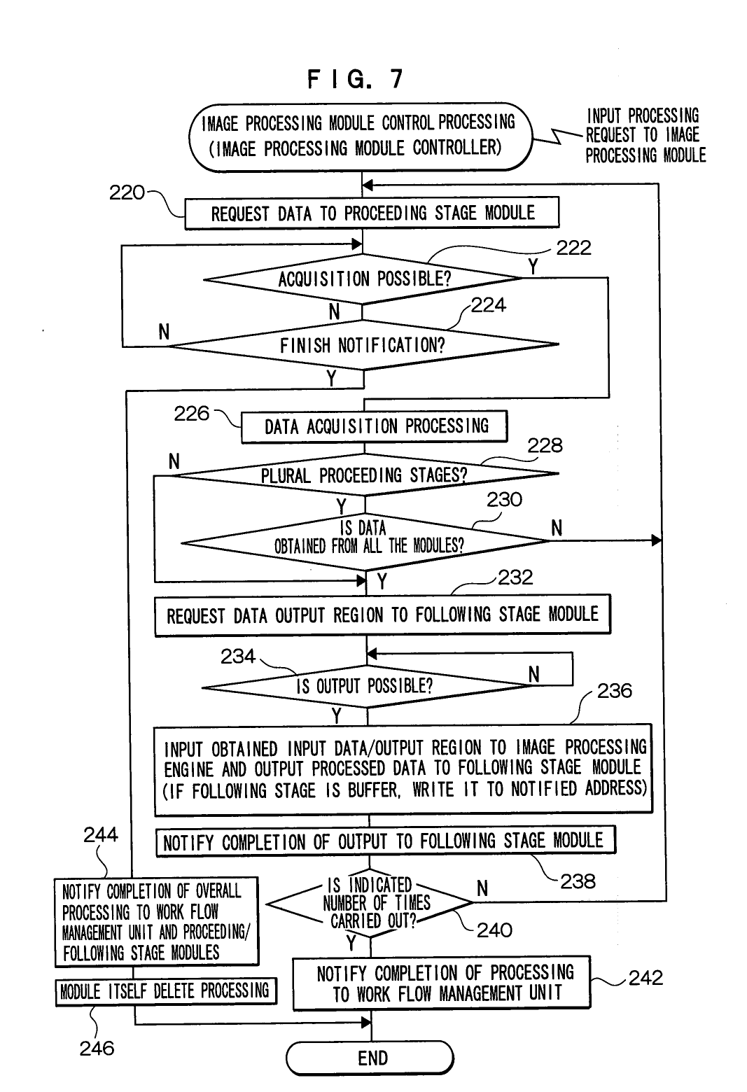

Subsequently, image processing module control processing (FIG. 7), which is carried out by the controllers 38B of the respective image processing modules 38 each time a processing request is input from the work flow management unit 46A to the respective image processing modules 38 constituting the image processing unit 50, will be explained. In the image processing module control processing, first, at step 220, data (image data or a result of processing of image data such as analysis) is requested to the module at the proceeding stage when a module (a buffer module 40, an image data supply unit 22, an image processing module 38, and the like) exists at the proceeding stage of the module itself. At next step 222, it is determined whether or not data can be obtained from the module at the proceeding stage, and when the determination is No at step 222, it is determined at step 224 whether or not it is notified that overall processing has been finished. When the determination is No at step 224, the process returns to step 222 at which steps 222 and 224 are repeated until the data can be obtained from the module at the proceeding stage. When the determination is Yes at step 222, data acquisition processing is carried out at step 226 to obtain the data from the module at the proceeding stage.

When data is requested (the read request) at previous step 222 at the time the module at the proceeding stage of the module itself is the buffer module 40, the leading head address of the read region is notified from the buffer module 40 and it is requested to read the image data instantly when the readable available data is stored in the buffer 40A of the buffer module 40 in an amount equal to or larger than the unit amount of read data or the trailing end of the readable available data is in agreement with the trailing end of the image data to be processed (refer also to step 192 of FIG. 5). When the above statuses are not achieved, the leading head address of the read region is notified from the buffer module 40 and it is requested to read the image data after a change to the above statuses is achieved by that the image processing module 38 at the proceeding stage of the buffer module 40 writes image data to the buffer 40A of the buffer module 40. With this operation, the determination at step 222 becomes Yes, and the process goes to step 226 at which data acquisition processing is carried out to read the image data of the unit amount of read data (or in an amount less than it) from the read region whose leading head address is notified from the buffer module 40 at the proceeding stage (refer also to (3) of FIG. 8A).

Further, if the module at the proceeding stage of the module itself is the image data supply unit 22, when the data request is output at previous step 220, it is notified instantly that the image data can be obtained from the image data supply unit 22 at the proceeding stage. Accordingly, the determination at step 222 becomes Yes, and the process goes to step 226 at which image data acquisition processing is carried out to obtain the image data from the image data supply unit 22 in the unit amount of read data. Further, if the module at the proceeding stage of the module itself is the image processing unit 38, when a data request (processing request) is output at previous step 220, it is notified that when the image processing module 38 at the proceeding stage can carry out image processing, data (a result of image processing) can be obtained by inputting a write request. Accordingly, the determination at step 222 becomes Yes, and the process goes to step 226 at which data acquisition processing for writing the data output from the image processing module 38 at the proceeding stage to the buffer is carried out by requesting writing by notifying the address of a buffer region to which the data is written by the image processing module 38 at the proceeding stage.

At next step 228, it is determined whether or not plural modules are coupled with the proceeding stage of the module itself. When the determination is No, the process goes to step 232 without carrying out any processing. However, when the determination is Yes, the process goes to step 230 at which it is determined whether or not data has been obtained from all the modules coupled with the proceeding stage. When the determination is No at step 230, the process returns to step 220 at which steps 220 to 230 are repeated until the determination at step 230 becomes Yes. When acquisition of all the data to be obtained from the modules at the proceeding stage is finished, the determination at step 228 becomes No or the determination at step 230 becomes Yes, and the process goes to step 232.

Next, at step 232, a data output region is requested to the module at the following stage of the module itself, and determination is carried out until the data output region can be obtained (until the leading head address of the data output region is notified) at step 232. Note that if the module at the following stage is the buffer module 40, the request for the data output region is carried out by outputting a write request to the buffer module 40. When the data output region (if the module at the following stage is the buffer module 40, when the write region whose leading head address is notified from the buffer module 40) can be obtained (refer also to (4) of FIG. 8A), at next step 236, the data obtained by the previous data acquisition processing and the leading head address of the data output region obtained from the module at the following stage are input to the image processing engine 38A, and predetermined image processing is carried out to the input data (refer also to (5) of FIG. 8A) as well as the data subjected to the processing is also written to the data output region (refer also to (6) of FIG. 8A). When the data has been input to the image processing engine 38A in the unit amount of read data and all the data output from the image processing engine 38A is written to the data output region, it is notified at next step 238 that the output has been completed.

The processing (unit processing) to the data of the unit amount of processing data is completed in the image processing module 38 at steps 220 to 238. However, in a processing request input from the work flow management unit 46A to the image processing module 38, a number of times of execution of the unit processing may be designated by the work flow management unit 46A. Accordingly, at step 240, it is determined whether or not the number of times of execution of the unit processing has reached the number of times of execution designated by the processing request. When the designated number of times of execution of the unit processing is a single time, the determination becomes Yes unconditionally. However, when the designated number of times of execution is two or more, the process returns to step 220 at which steps 220 to 240 are repeated until the determination at step 240 becomes Yes. When the determination at step 240 becomes Yes, the process goes to step 242 at which a processing completion notification is output to the work flow management unit 46A, and it is notified to the work flow management unit 46A that the processing corresponding to the input processing request is completed. Then, the image processing module control processing is finished.

Further, when the image data to be processed is processed up to the trailing end thereof by repeating the processing described above each time the processing request is input from the work flow management unit 46A, it is notified from the module at the proceeding stage that image data to be processed is ended. As a result, the determination at step 224 becomes Yes, and the process goes to step 244 at which an overall processing completion notification, which means that the processing to the image data to be processed (note that, although the image data to be processed is image data of one page in many cases, it may be image data of plural pages), is output to the work flow management unit 46A and the module at the following stage, respectively. Further, at next step 246, module itself delete processing (to be described later) is carried out, and the image processing module control processing is finished.

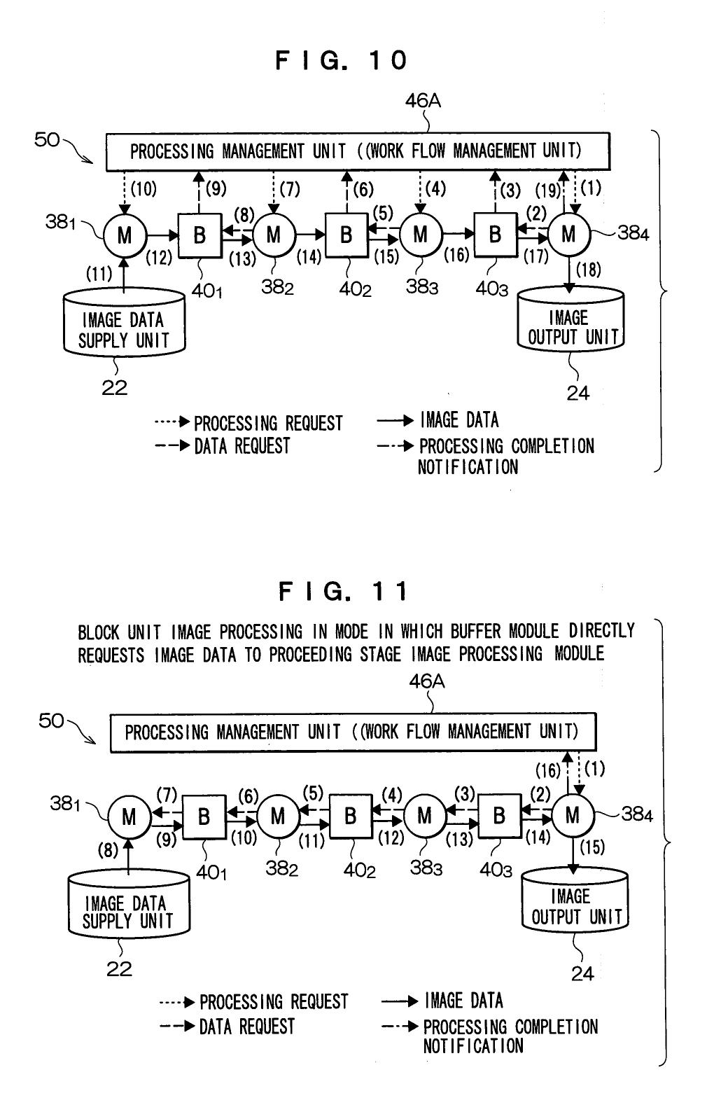

On the other hand, when the work flow management unit 46A is started by the application 32, it carries out block unit control processing 1 shown in FIG. 9A. As described above, in the input of the processing request to the respective image processing modules 38 of the processing unit 50 carried out by the work flow management unit 46A, the number of times of execution of the unit processing can be designated. However, at step 500 of the block unit control processing 1, the number of times of execution of the unit processing, which is designated by a processing request issued once, is determined for each of the respective image processing modules 38. Although the number of times of execution of the unit processing per one processing request can be determined, for example, such that the number of input times of the processing request to the respective image processing modules 38 can be averaged while the overall image data to be processed is processed. However, it may be determined based on another standard. At next step 502, the processing request is input to the image processing module 38 at the rearmost stage in the image processing unit 50 (refer also to (1) of FIG. 10), and the block unit control processing 1 is finished.

In the image processing unit 50 shown in FIG. 10, when the processing request is input from the work flow management unit 46A to an image processing module 384 at the rearmost stage, the controller 38B of the image processing module 384 inputs a read request to a buffer module 403 at the proceeding stage (refer also to (2) of FIG. 10). At this time, since no available data (no image data), which can be read by the image processing module 384, is stored in the buffer 40A of the buffer module 403, the buffer controller 40B of the buffer module 403 inputs a data request to the work flow management unit 46A (refer to (3) of FIG. 10).

When image processing is carried out in a block unit processing mode, the work flow management unit 46A carries out block unit control processing 2 shown in FIG. 9B each time a data request is input from the buffer module 40. In the block unit control processing 2, at step 504, the image processing module 38 (here, an image processing module 383) at the proceeding stage of the buffer module 40 (here, the buffer module 403) of a data request input source is recognized, and a processing request is input to the recognized image processing module 38 at the proceeding stage, and the processing is finished (refer to (4) of FIG. 10).

When the processing request is input, the controller 38B of the image processing modules 383 inputs a read request to a buffer module 402 at the proceeding stage (refer to (5) of FIG. 10), and a buffer controller 40B of the buffer module 402 inputs a data request to the work flow management unit 46A (refer to (6) of FIG. 10) because also no readable image data is stored in the buffer 40A of the buffer module 402. When the data request is input from the buffer module 402, the work flow management unit 46A also inputs a processing request to the image processing module 382 at the proceeding stage by carrying out the block unit control processing 2 described above again (refer to (7) of FIG. 10), and the controller 38B of the image processing module 383 inputs a read request to a buffer module 401 at the proceeding stage (refer to (8) of FIG. 10). Further, since no readable image data is stored in the buffer 40A of the buffer module 401, the buffer controller 40B of the buffer module 401 also inputs a data request to the work flow management unit 46A (refer to (9) of FIG. 10). When the data request is input from the buffer module 40, the work flow management unit 46A also inputs a processing request to an image processing module 38, at the proceeding stage by carrying out the block unit control processing 2 described above again (refer to (10) of FIG. 10).

Since the module at the proceeding stage of the image processing module 38, is the image data supply unit 22, the controller 38B of the image processing module 38, obtains the image data of the unit amount of read data from the image data supply unit 22 by inputting a data request to the image data supply unit 22 (refer to (11) of FIG. 10) and writes the image data, which is obtained by subjecting the thus obtained image data to image processing by the image processing engine 38A, to the buffer 40A of the buffer module 401 at the following stage (refer to (12) of FIG. 10). Note that, on the completion of writing of the image data to the buffer 40A of the buffer module 40, at the following stage, the controller 38B of the image processing modules 38, inputs a processing completion notification to the work flow management unit 46A.

When the image processing is carried out in the block unit processing mode, the work flow management unit 46A carries out block unit control processing 3 shown in FIG. 9C each time the processing completion notification is input from the image processing modules 38. In the block unit control processing 3, at step 506, it is determined whether or not an input source of the processing completion notification is the image processing module 38 at the rearmost stage of the image processing unit 50. In this case, since the determination is No, the processing is finished without carrying out any processing (this is the same when the processing completion notification is input from the image processing modules 382, 383).

Further, when the available data, which is larger than the unit amount of read data that can be read by the image processing module 382 at the following stage, is written, the buffer controller 40B of the buffer module 40, requests the image processing modules 382 to read the available data. Accordingly, the controller 38B of the image processing modules 382 reads the image data of the unit amount of read data from the buffer 40A of the buffer module 40, (refer to (13) of FIG. 10) and writes the image data, which is obtained by subjecting the thus obtained image data to image processing by the image processing engine 38A to the buffer 40A of the buffer module 402 at the following stage (refer to (14) of FIG. 10). When the available data, which is larger than the unit amount of read data that can be read by the image processing module 383 at the following stage, is written, the buffer controller 40B of the buffer module 402 requests the image processing modules 383 to read the available data. Accordingly, the controller 38B of the image processing modules 383 reads the image data of the unit amount of read data from the buffer 40A of the buffer module 402 (refer to (15) of FIG. 10) and writes the image data, which is obtained by subjecting the thus obtained image data to image processing by the image processing engine 38A, to the buffer 40A of the buffer module 403 at the following stage (refer to (16) of FIG. 10).

Further, when the available data, which is larger than the unit amount of read data that can be read by the image processing module 384 at the following stage, is written, the buffer controller 40B of the buffer module 403 requests the image processing modules 384 to read the available data. Accordingly, the controller 38B of the image processing modules 384 reads the image data of the unit amount of read data from the buffer 40A of the buffer module 403 (refer to (17) of FIG. 10) and outputs the image data, which is obtained by subjecting the thus obtained image data to image processing by the image processing engine 38A, to the image output unit 24 as the module at the following stage (refer to (18) of FIG. 10). Further, on the completion of writing of the image data to the image output unit 24 at the following stage, the controller 38B of the image processing module 384 inputs a processing completion notification to the work flow management unit 46A (refer to (19) of FIG. 10). In this case, the determination at step 506 of the block unit control processing 3 becomes Yes, the process goes to step 508 at which a processing request is input again to the image processing modules 384 as the image processing module 38 at the rearmost stage, and then the processing is finished.

The processing sequence described above is repeated again by inputting the processing request to the image processing module 384 of the rearmost stag again, so that image processing is sequentially carried out to the image data to be processed in the block unit processing mode. When the image data supplied from the image data supply unit 22 reaches the trailing end of the image data to be processed, an overall processing completion notification is sequentially input from the respective image processing modules 38 at the proceeding stage to the work flow management unit 46A.

When the image processing is carried out in the block unit processing mode, the work flow management unit 46A carries out block unit control processing 4 shown in FIG. 9D each time the overall processing completion notification is input from the image processing module 38. In the block unit control processing 4, at step 510, it is determined whether or not the image processing module 38 of an input source of the overall processing completion notification is the image processing module 38 at the rearmost stage. When the determination is No, the processing is finished without carrying out any processing. However, when the overall processing completion notification is input from the image processing module 38 at the rearmost stage because all the image data, which is obtained by subjecting the image data to be processed to necessary image processing, is output to the image output unit 24, the determination at step 510 becomes Yes, the process goes to step 512 at which completion of the image processing is notified to the application 32, and the block unit control processing is finished. Then, the application 32, to which the completion of the image processing is notified, notifies the completion of the image processing to the user.

As described above, in the block unit processing, a series of image processings are carried out in such a manner that when the processing request input to the image processing module 38 at the rearmost stage goes back to an image processing module 38 of a more proceeding stage and reaches the image processing module 38 at the frontmost stage, image processing is carried out in the image processing module 38 at the frontmost stage, data is written to the buffer module 40 at a following stage, and when the data is sufficient, the processing goes to the module at a following stage.

Note that the processing sequence in the block unit processing is not limited to the above one. That is, instead of inputting the processing request to the buffer module 40 of the data request input source each time the data request is input from the buffer module 40, processing may be carried out to all the image processing modules in such a manner that, first, the processing request is input to all the image processing modules 38 in the block unit control processing 1 and the processing request is input again to a specific image processing module 38 of the input source of the processing completion notification, each time the processing completion notification is input from the specific image processing module 38 during a period of time until the overall processing completion notification is input from the specific image processing module.

Further, in the above description, although the work flow management unit 46A inputs the processing request to the image processing module 38 at the rearmost stage, the present invention is not limited thereto. That is, the processing request may be carried out while holding the modules located at the rearmost stage of the pipe line or holding the modules located at plural terminal points of the directed acyclic graph by the work flow management unit 46A or by holding the application 32. Or, when a skew correction processing module is arranged by combining an image processing module for carrying out the skew angle detection processing and an image processing module for carrying out the image rotation processing in the module generation unit 44 as an example of FIG. 2B described above, skew angle information is necessary as a processing parameter when an image rotation processing module is generated. Accordingly, there is also a method of processing an overall image by repeating the processing request to a skew angle detection processing module in a skew correction module generation unit and applying resultant skew angle information to the image rotation processing module as a processing parameter.

Now, deletion of the image processing unit 50, which is carried out after the image processing with respect to the image data to be processed is completed, will be explained. The controllers 38B of the respective image processing modules 38 outputs the overall processing completion notification to the work flow management unit 46A and the module at the following stage at step 244 of the image processing module control processing (FIG. 7), and then they delete the module itselfs at next step 246. Specifically, the memory region secured previously is released by the resource management unit 46B and, when there is a resource other than the memory secured by the module itself through the resource management unit 46B, the resource is released by the resource management unit 46B, a delete notification is input to the module at the proceeding stage of the module itself, the module at the following stage, and the work flow management unit 46A notifying that processing for deleting the module itself is to be carried out, and then the processing for deleting the module itself is carried out. Note that the module itself can be deleted by finishing the process and the thread to the module itself or deleting the object to them.

On the other hand, in the data write processing (FIG. 3) carried out by the write controller 40C of the buffer module 40, when the delete notification is input from the image processing module 38 at the proceeding or following stage of the module itself, the determination at step 104 becomes Yes, and the process goes to step 146 at which after the module of a delete notification input source is stored, it is determined whether or not the delete notification is input from all the modules at the proceeding and the following stages of the module itselfs. When the determination is No, the data write processing is finished once. Further, when the delete notification is input from all the modules at the proceeding and the following stages of the module itselfs, the determination at step 146 is Yes, and the process goes to step 148 at which the delete notification is input to the work flow management unit 46A, so that notification of carrying out processing for deleting the module itself is made. Then, the processing for deleting the module itself is carried out at next step 150, and the data write processing is finished.

Note that, in the data write processing (FIG. 3) described above, although it is an embodiment in which the compression processing is carried out uniformity when image data input from the image processing module 38 at the proceeding stage is not compressed, has been explained, the present invention is not limited thereto. That is, when image data is input from the image processing module 38 at the proceeding stage, the vacant capacity of a system resource such as the memory 14 that can be used as the buffer 40A of the buffer module 40 (or the vacant capacity of the buffer 40A when the memory 14 having a predetermined capacity is previously allocated as the buffer 40A at the time the buffer module 40 is generated) may be detected, and when the detected vacant capacity is larger than a predetermined value, the image data may be written to the buffer 40A as it is without being compressed even if it is not compressed. In this embodiment, a load applied to the CPU 12, which carries out data write processing (compression processing) and data read processing (expansion processing), can be reduced although the capacity of the buffer 40A for storing the input image data is increased. Note that the above embodiment corresponds to a modification of the second aspect of the present invention.

Further, although an example of the memory 14 is explained above as the system resource which can be used as the buffer 40A of the buffer module 40, the present invention is not limited thereto, and an HDD and a flash memory, and various types of external storage devices connected to the computer 10 through a communication circuit may be also used as the buffer module 40 in addition to the memory. Further, when a storage device used as the buffer 40A of the buffer module 40 can be selected from the plural types of the storage devices, an access speed to the buffer 40A is different depending on a type of a storage device used as the buffer module 40A and on an environment such as a line speed of a communication circuit to the storage device. When this is taken into consideration, non-compressed input image data may be written to the buffer 40A as it is without being compressed when the non-compressed image data from the image processing module 38 at the proceeding stage is input in such an environment that the buffer 40A, to which the image data is written, is composed of a storage device having an access speed equal to or higher than a first predetermined value (for example, a high speed storage device such as the memory 14) and that a data transfer speed to the buffer 40A is equal to or higher than a second predetermined value (when, for example, the buffer 40A is composed of a high speed storage device as well as a high speed communication circuit is wired to the buffer 40A). Whereas, in an environment in which the buffer 40A, to which image data is written, is composed of a storage device (for example, a low speed storage device such as a flash memory, an external storage device) having an access speed less than the first predetermined speed and in which a data transfer speed to the buffer 40A is less than the second predetermined value (for example, the buffer 40A is composed of a low speed storage device, or a low speed communication circuit is wired to the buffer 40A), the non-compressed input image data may be written to the buffer 40A after it is compressed. With these operations, when the buffer 40A is accessed at a low speed, the processing speed can be prevented from being greatly reduced in the image processing unit 50 as well as preventing a load larger than necessary from being applied to the CPU 12.

Further, in the above arrangement, when the image data to be read is image data compressed by the data write processing at the time the read request is input from the image processing module 38 at the following stage, although the image data is delivered to the image processing module 38 of the read request source after it is read from the buffer 40A and expanded, the present invention is not limited thereto. That is, there is also contemplated as an arrangement of the image processing module 38, for example, an arrangement having such a function that the compressed image data obtained from the module at the proceeding stage is subjected to image processing after it is expanded, and an arrangement having such a function that the compressed image data obtained from the module at the proceeding stage is subjected to image processing without being expanded, that is, an arrangement in which the compressed image data can be input. Accordingly, when the image processing module 38 at the following stage is arranged as described above, even if the image data to be read is image data compressed by the data write processing, the image data may be delivered to the image processing module 38 at the following stage after information showing a compression system is added to the image data as the attribute information without carrying out the expansion processing to the image data. In this case, a load applied to the CPU 12, which carries out the data read processing, can be reduced.

Further, there are various systems as the compression system of image data. However, even if the image processing module 38 at the following stage is arranged such that compressed image data can be input thereto, there is a high possibility that a compression system of image data, which can be handled by the image processing module 38 at the following stage, is limited. Accordingly, a compression system, which can be handled by the image processing module 38 at the following stage, may be recognized when the buffer module 40 is initialized, and the image data may be compressed by the compression system recognized in the initialization in the data write processing.

Further, in the data write processing described above, since the input image data is written to the buffer region without being compressed during a period of time until 0 is set to the detection flag (during a period of time until the image data is input from the image processing module 38 at the proceeding stage N+1 times), even if the image data input from the image processing module 38 at the proceeding stage is non-compressed image data, the leading head portion of the image data (the portion having a size corresponding to the unit amount of write data×(N+1) from the leading head) is written to the buffer region without being compressed. However, the present invention is not limited thereto. That is, for example, the size of the write buffer region may be set to a size that permits image data having a size corresponding to the unit amount of write data×(N+1) to be written, the input image data may be accumulated to the write buffer region during a period of time until whether the input image data is compressed or not is determined, and when it is determined that the input image data is compressed, the image data accumulated in the write buffer region may be written to the storage buffer region as it is, and when it is determined that the input image data is not compressed, the image data accumulated in the write buffer region may be written to the storage buffer region after it is entirely compressed.

Further, in the above arrangement, the example has been explained in which the data request is repeatedly input from the buffer module 40 to the work flow management unit 46A until it is detected that the amount of the readable available data is equal to or larger than the unit amount of read data or that the trailing end of the readable available data is the trailing end of the image data to be processed when the amount of the readable available data, which can be read by the image processing module 38 of the read request source, is less than the unit amount of read data as well as the trailing end of the readable available data is not the trailing end of the image data to be processed, although the read request is input from the image processing module 38 at the following stage to the buffer module 40. However, the present invention is not limited thereto. That is, in the above case, the buffer module 40 may input the data request to the work flow management unit 46A only once and when it is detected that the amount of the readable available data is equal to or larger than the unit amount of read data or the trailing end of the readable available data is the trailing end of the image data to be processed, an accumulation completion notification may be input to the work flow management unit 46A, and the work flow management unit 46A may repeatedly input the processing request to the image processing module 38 at the proceeding stage of the buffer module 40 during a period of time from a time at which the data request is input from the buffer module 40 to a time at which the accumulation completion notification is input.

Further, explained above is an example of an embodiment in which the buffer module 40 is arranged such that when the read request is input from the image processing module 38 at the following stage and the available data, which can be read by the image processing module 38 of the read request source, is not stored in the buffer 40A of the module itself, the buffer controller 40B inputs the data request to the work flow management unit 46A. However, the present invention is not limited thereto, and, in the above case, the buffer controller 40B may directly input the data request to the image processing module 38 at the proceeding stage. FIG. 11 shows a processing sequence when the image processing is carried out in the block unit processing mode. As apparent also from FIG. 11, in this mode, it is sufficient for the work flow management unit 46 to input the processing request only to the image processing module 38 at the rearmost stage in the image processing unit 50. Accordingly, the processing in the work flow management unit 46A can be simplified.

Further, in the image processing of the block unit explained above as an example, first, the work flow management unit 46A inputs the processing request to the image processing module 38 at the rearmost stage of the image processing unit 50 and the processing request is sequentially transmitted to the modules at the proceeding stages as the data request or the processing request. However, the present invention is not limited thereto, and it is also possible to carry out the image processing of the block unit by sequentially transmitting the processing request or the data request from a module at a proceeding stage to a module at a following stage. This can be realized by, for example, arranging the buffer controller 40B of the buffer module 40 such that each time image data is written to the buffer 40A by the image processing module 38 at the proceeding stage of the module itself, the image processing module 38 at the following stage inputs the data request to the work flow management unit 46A when the amount of the readable available data is less than the unit amount of read data as well as the trailing end of the readable available data is not the trailing end of image data to be processed, whereas when it is detected that the amount of the readable available data is equal to or larger than the unit amount of read data or the trailing end of the readable available data is the trailing end of the image data to be processed, the accumulation completion notification is input to the work flow management unit 46A, and arranging the work flow management unit 46A such that after the processing request is input to the image processing module 38 at the rearmost stage of the image processing unit 50, each time the data request is input from an arbitrary buffer module 40, the processing request is input to the image processing module 38 at the proceeding stage of the buffer module 40 of the data request source, and each time the accumulation completion notification is input from an arbitrary buffer module 40, the processing request is input to the image processing module 38 at the following stage of the buffer module 40. Further, in the above arrangement, the data request may be directly input to the image processing module 38 at the proceeding stage of the buffer module 40 as the processing request, and the accumulation completion notification from the buffer module 40 may be directly input to the image processing module 38 at the following stage of the buffer module 40 as the processing request.

Further, in the embodiment described above, the unit amount of write data is previously set to the buffer module 40 from the image processing module 38 at the proceeding stage and the unit amount of read data is previously set to the buffer module 40 from the image processing module 38 at the following stage. However, the present invention is not limited thereto, and an amount of data to be written or read may be notified from the image processing module 38 each time data is written and read to and from the buffer module 40.

Further, in the above arrangement, the exclusive control is realized in such a manner that each time the write request or the read request is input to the buffer module 40, the input request is registered to the queue as request information, and respective pieces of the information is fetched from the queue one by one so that when data is being read from the buffer 40A at the time the write request is input, data write processing corresponding to the write request is carried out at the time the data has been read, and when data is being written to the buffer 40A at the time the read request is input, data read processing corresponding to the read request is carried out at the time the data has been written. However, the present invention is not limited thereto, and an exclusive control using, for example, the unit buffer region as a unit may be carried out. That is, when data is being read from the unit buffer region of the buffer 40A to which data is requested to be written when the write request is input, data write processing corresponding to the write request may be carried out after the data has been read, and when data is being written to the unit buffer region of the buffer 40A from which data is requested to be read at the time the write request is input, data read processing corresponding to the read request may be carried out after the data has been written. The exclusive control using the unit buffer region as the unit, can be realized by, for example, carrying out the exclusive control by providing each unit buffer region with a queue, using a known technology such as mutex (MUTual Exclusion service) that can be used for the exclusive control.

Further, since the respective modules constituting the image processing unit 50 is a program, image processing carried out by the image processing unit 50 is actually carried out by the CPU 12. Here, programs corresponding to the respective image processing modules 38 constituting the image processing unit 50 are registered to a queue as a process, a thread, or an object of a target to be carried out by the CPU 12, and each time a program corresponding to a specific image processing module registered to the queue is fetched from the queue by the CPU 12, it is determined whether or not image data of the unit amount of processing data can be obtained from the module at the proceeding stage of a specific image processing module 38. Only when it is determined that the image data of the unit amount of processing data can be obtained, the image data of the unit amount of processing data is obtained from the module at the proceeding stage of the specific image processing module 38, predetermined image processing (processing corresponding to the image processing engine 38A of the specific image processing module) is carried out to the thus obtained image data of the unit amount of processing data. After processing for outputting a result processing of the image data subjected to the predetermined image processing or a result of processing of the predetermined image processing to the module at the following stage of the module itself is carried out, if the processing to the overall image to be processed is not finished, the CPU 12 is caused to repeat unit image processing for registering again the program corresponding to the fetched specific image processing module to the queue as the process, the thread or the object of a target to be carried out. In this way, an overall image to be processed may be processed by the image processing unit 50 (a round-robbin system).

Further, in the foregoing, the mode has been explained in which the work flow management unit 46A carries out control such that the image processing unit carries out the block unit processing overall by operating the respective image processing modules 38 of the image processing unit such that they carry out image processings in parallel while delivering image data to the following stage using an amount of data smaller than one sheet of image as a unit. However, the present invention is not limited thereto. Specifically, the work flow management unit 46A may be arranged such that the image processing unit can also carry out sheet unit processing overall in such a manner that after the respective image processing modules 38 of the image processing unit finish image processing to image data of one sheet of image, the image processing module 38 at the following stage is operated to carry out image processing with respect to the image data of one sheet of image.

What is claimed is:

1. An image processing apparatus comprising:
an image processing unit structured to comprise:
one or more image processing modules, each of which has a function for obtaining image data of a unit amount of data from a proceeding stage of the image processing module, carrying out predetermined image processing with respect to the obtained image data, and outputting the image data has undergone the predetermined image processing or a result of processing of the predetermined image processing to a following stage of the image processing module, the one or more image processing modules being selected from a plurality of types of image processing modules that carry out image processing that are different in type or contents from each other; and
one or more buffer modules each having a buffer for storing image data;
the image processing unit being structured such that the buffer modules are connected to at least one of a proceeding stage and/or a following stage of the selected respective image processing modules with the modules coupled to each other in a pipe line mode or in a directed acyclic graph mode,
each of the buffer modules includes,
a write unit that when image data to be written is input from the module at the proceeding stage, switches a writing method depending on whether or not the input image data is compressed, and writes the image data to the buffer, and
a read unit that when image data is requested to output from the module at the following stage, switches an output method depending on whether or not the image data reads from the buffer is compressed, and outputs the image data to the module at the following stage.

2. The image processing apparatus of claim 1, wherein the write unit determines whether or not the image data to be written input from the module at the proceeding stage is compressed, and when it is determined that the image data is compressed, the write units writes the image data to the buffer, and when it is determined that the image data is not compressed, compression processing of the image data is carried out and the write unit writes the compressed image data to the buffer.

3. The image processing apparatus of claim 1, wherein
the image data is input to the buffer module from the module at the stage proceeding the buffer module separately for respective predetermined unit regions constituting the image, and
the write unit compares the sizes of the input data of the unit regions while the data of the unit regions is input a predetermined number of times from the module at the proceeding stage, and when the sizes of the input data of a predetermined number of the unit regions are substantially the same as each other, it is determined that the image data input from the module at the proceeding stage is not compressed, whereas when the sizes of the input data of the predetermined number of the unit regions are not substantially the same as each other, it is determined that the image data input from the module at the proceeding stage is compressed.

4. The image processing apparatus of claim 2, wherein
the image data is input to the buffer module from the module at the stage proceeding the buffer module separately for respective predetermined unit regions constituting the image, and
the write unit compares the sizes of the input data of the unit regions while the data of the unit regions is input a predetermined number of times from the module at the proceeding stage, and when the sizes of the input data of a predetermined number of the unit regions are substantially the same as each other, it is determined that the image data input from the module at the proceeding stage is not compressed, whereas when the sizes of the input data of the predetermined number of the unit regions are not substantially the same as each other, it is determined that the image data input from the module at the proceeding stage is compressed.

5. The image processing apparatus of claim 2, wherein when the vacant capacity of the buffer, or the vacant capacity of a system resource that can be used as the buffer, is equal to or larger than a predetermined value, the write unit writes the image data to the buffer without carrying out the compression processing even if the write unit determines that the input image data is not compressed.

6. The image processing apparatus of claim 2, wherein when the write unit determines that the input image data is not compressed,
if a device constituting the buffer is a storage device having an access speed equal to or higher than a first predetermined value, the write unit writes the image data to the buffer without carrying out the compression processing of the image data, and
if the device constituting the buffer is a storage device having an access speed less than the first predetermined, compression processing of the image data is carried out and the write unit writes the compressed image data to the buffer.

7. The image processing apparatus of claim 2, wherein when the write unit determines that the input image data is not compressed,
if a data transfer speed to the buffer is equal to or higher than a second predetermined value, the write unit writes the image data to the buffer without carrying out the compression processing of the image data, and
if the data transfer speed to the buffer is less than the second predetermined value, compression processing of the image data is carried out and the write unit writes the compressed image data to the buffer.

8. The image processing apparatus of claim 2, wherein when the image data read from the buffer in response to a request to output from a module at the following stage is image data that has not undergone compression processing by the write unit, the read unit outputs the read image data to the module at the following stage, whereas when the read image data is image data that has undergone the compression processing by the write unit, expansion processing of the image data is carried out and the read unit outputs the expanded image data to the module at the following stage.

9. The image processing apparatus of claim 2, wherein the read unit, when the module at the stage following the buffer module of the read unit is an image processing module having a function for carrying out image processing of the compressed image data obtained from the module at the stage proceeding the image processing module after carrying out expansion processing of the compressed image data, or a function for carrying out image processing of the compressed image data obtained from the module at the stage proceeding the image processing module without carrying out expansion processing of the compressed image data, even if the read image data is compressed image data has undergone compression processing, the read unit does not carry out the expansion processing but adds attribute information representing the compression format applied to the compressed image data to the compressed image data, and causes the image processing module at the stage following the buffer module to carry out the image processing after carrying out the expansion processing of the compressed image data or causes the image processing module at the stage following the buffer module to carry out the image processing without carrying out the expansion processing.

10. A storage medium in which is stored an image processing program for causing a computer to act as an image processing apparatus comprising an image processing unit structured to comprise:
one or more image processing modules, each of which has a function for obtaining image data of a unit amount of data from a proceeding stage of the module itself, carrying out predetermined image processing with respect to the obtained image data, and outputting the image data subjected to the predetermined image processing or a result of processing of the predetermined image processing to a following stage of the module itself, the one or more image processing modules being selected from plural types of image processing modules that carry out image processing that are different in type or contents from each other; and
one or more buffer modules each having a buffer for storing image data;
the image processing unit being structured such that the buffer modules are coupled to at least one of a proceeding stage and/or a following stage of the selected respective image processing modules with the modules coupled to each other in a pipe line mode or in a directed acyclic graph mode,
each of the buffer modules comprising:
a write unit that when image data to be written is input from the module at the proceeding stage, switches a writing method depending on whether or not the input image data is compressed, and writes the image data to the buffer; and
a read unit that when image data is requested from the module at the following stage, switches an output method depending on whether or not the read image data is compressed, reads the image data from the buffer, and outputs the image data to the module at the following stage.
